(19) United States
(12) Patent Application Publication
(10) Pub. No.: US 2026/0112670 A1
(43) Pub. Date: Apr. 23, 2026

(54) METHODS AND SYSTEMS FOR OPTIMIZING OPERATION OF AN ELECTROCHEMICAL SYSTEM

(71) Applicant: ELECTRIC HYDROGEN CO., Devens, MA (US)

(72) Inventors: Shabab Akbari, San Jose, CA (US); Peter Matthews, South San Francisco, CA (US); Curt C. Ebner, Redwood City, CA (US)

(21) Appl. No.: 19/156,811

(22) PCT Filed: Apr. 28, 2025
(86) PCT No.: PCT/US2025/026624

§ 371 Date: Aug. 14, 2025

Related U.S. Application Data
(60) Provisional application No. 63/652,431, filed on May 28, 2024.
(60) Provisional application No. 63/667,227, filed on Jul. 3, 2024.

(51) Int. Cl. H01M 8/04992; H01M 8/0438; H01M 8/04746

(52) U.S. Cl. CPC H01M 8/04992; H01M 8/04395; H01M 8/04753

(57) ABSTRACT

The following disclosure relates to systems and methods for optimizing an operation of an electrochemical system. An optimization system may include a processor configured to determine an adjustment to one or more setpoints for the operation of the electrochemical system based on an optimization model that takes into account a desired performance parameter, an operating load point of the electrochemical system, and/or operating conditions of the electrochemical system received by the processor. In other examples, the optimization system includes a controller configured to: receive desired operating set points for operation of an electrochemical system; receive operating conditions of the electrochemical system; and determine an adjustment to an off-taker control valve, an electrochemical stack pressure control valve, a power supply unit, or a combination thereof based on an optimization model.

This application claims the benefit of U.S. Provisional Patent Application No. 63/652,431, filed May 28, 2024, and U.S. Provisional Patent Application No. 63/667,227, filed Jul. 3, 2024, which are hereby incorporated by reference in their entireties.

### FIELD

The following disclosure relates to an electrochemical system and components thereof. More specifically, the following disclosure relates to systems and methods for optimizing operation of an electrochemical system having an electrochemical stack.

### BACKGROUND

An electrochemical cell or system uses electrical energy to drive a chemical reaction. For example, within a water splitting electrolysis reaction within the electrolysis cell, water is split to form hydrogen and oxygen. The products may be used as energy sources for later use. In recent years, improvements in operational efficiency have made electrolyzer systems competitive market solutions for energy storage, generation, and/or transport. For example, the cost of generation may be below $6 per kilogram of hydrogen in some cases. Increases in efficiency and/or improvements in operation will continue to drive installation of electrolyzer systems.

Optimizing the operation of an electrochemical system is a multifaceted endeavor, crucial for efficiency and sustainability. The electrochemical system includes electrolyzer stacks, pumps, rectifiers, chillers, and other systems, each with its electricity consumption patterns and potential for degradation.

However, there is a challenge in efficiently running the electrochemical system, including, e.g., efficiently operating the electrochemical system to ensure stability at the point of customer delivery. Addressing these challenges is pivotal for achieving the desired balance between electricity consumption, equipment longevity, and the sustainable production of hydrogen. Addressing these challenges may also be pivotal for attaining the desired equilibrium among electricity consumption, equipment durability, and sustainable hydrogen production.

As such, there remains a need to provide a system and method for optimizing an operation of the electrochemical system.

### SUMMARY

In one embodiment, a method for optimizing an operation of an electrochemical system is provided. The method includes receiving a desired performance parameter for the operation of the electrochemical system, receiving an operating load point of the electrochemical system, and receiving operating conditions of the electrochemical system. The method also includes determining an adjustment to one or more setpoints for the operation of the electrochemical system based on an optimization model. The optimization model takes into account the desired performance parameter, the operating load point of the electrochemical system, and the received operating conditions of the electrochemical system.

In another embodiment, a system for optimizing an operation of an electrochemical system is provided. The system includes a graphical user interface (GUI) for a user to visually interact with, and at least one processor. The at least one processor is configured to receive, via the GUI, a desired performance parameter for the operation of the electrochemical system. The at least one processor is further configured to receive an operating load point of the electrochemical system and receive operating conditions of the electrochemical system. Additionally, the at least one processor is configured to determine an adjustment to one or more setpoints for the operation of the electrochemical system based on an optimization model. The optimization model takes into account the desired performance parameter, the operating load point of the electrochemical system, and the operating conditions of the electrochemical system.

In another embodiment, a method for optimizing an operation of an electrochemical system having an electrochemical stack is provided. The method includes receiving desired operating set points for the operation of the electrochemical system having a delivery pressure set point at a point of delivery and an electrochemical stack pressure set point for a cathode side of the electrochemical stack. The method further includes receiving operating conditions of the electrochemical system having the pressure at the point of delivery and a pressure on the cathode side of the electrochemical stack. The method also includes determining an adjustment to an off-taker control valve, an electrochemical stack pressure control valve, a power supply unit, or a combination thereof based on an optimization model. In the method, the off-taker control valve controls a flow rate of hydrogen gas at the point of delivery from the electrochemical stack to the off-taker, the electrochemical stack pressure control valve controls the pressure on the cathode side of the electrochemical stack, the off-taker pressure transducer monitors the pressure at the point of delivery, the electrochemical stack pressure transducer monitors the pressure on the cathode side of the electrochemical stack, the power supply unit supplies an amount of current to the electrochemical stack, and the optimization model takes into account the operating conditions of the electrochemical system.

In a further embodiment, a system for optimizing an operation of an electrochemical system having an electrochemical stack is provided. The system includes: an off-taker control valve configured to control a flow rate of hydrogen gas at a point of delivery from the electrochemical stack to an off-taker; an electrochemical stack pressure control valve configured to control a pressure on a cathode side of the electrochemical stack; and an off-taker pressure transducer configured to monitor a pressure at the point of delivery. The system also includes: an electrochemical stack pressure transducer configured to monitor the pressure on the cathode side of the electrochemical stack; and a power supply unit configured to supply an amount of current to the electrochemical stack. Additionally, the system includes a controller configured to receive desired operating set points for the operation of the electrochemical system having a delivery pressure set point for the pressure at the point of delivery and an electrochemical stack pressure set point for the cathode side of the electrochemical stack. The controller is also configured to: receive operating conditions of the electrochemical system having the pressure at the point of delivery and the pressure on the cathode side of the electrochemical stack; and determine an adjustment to the off-taker control valve, the electrochemical stack pressure control valve, the power supply unit, or a combination thereof based on an optimization model. The optimization model takes into account the operating conditions of the electrochemical system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Exemplary embodiments are described herein with reference to the following drawings.

FIG. 1A depicts an example of an electrochemical or electrolytic cell.

FIG. 1B depicts an example of a system including an electrochemical stack having a plurality of electrochemical cells of FIG. 1A.

FIG. 2 depicts a first embodiment of an electrochemical optimization system for an electrochemical plant.

FIG. 3 depicts a second embodiment of an electrochemical optimization system for an electrochemical plant.

FIG. 4 depicts a flowchart describing a method for optimizing an operation of an electrochemical plant.

FIG. 5 depicts a flowchart describing a method for generating an optimization model for optimizing an operation of an electrochemical plant according to the first embodiment of the present disclosure.

FIG. 6 depicts a flowchart describing a method for generating an optimization model for optimizing an operation of an electrochemical plant according to the second embodiment of the present disclosure.

FIG. 7 depicts a third embodiment of an electrochemical optimization system for an electrochemical system having an electrochemical stack.

FIGS. 8-18 depict results provided from three different cases for optimizing an operation of an electrochemical system having an electrochemical stack.

FIG. 19 depicts a flowchart describing a method for optimizing an operation of an electrochemical system having an electrochemical stack.

FIG. 20 depicts a flowchart describing a method for optimizing an operation of an electrochemical system having an electrochemical stack when an amount of hydrogen consumption increases at a point of delivery to the off-taker.

FIG. 21 depicts a flowchart describing a method for optimizing an operation of an electrochemical system having an electrochemical stack when an amount of hydrogen consumption decreases at a point of delivery to the off-taker.

FIG. 22 illustrates an exemplary system for controlling operation of an electrochemical optimization system.

FIG. 23 illustrates an exemplary server of an embodiment of an electrochemical optimization system for an electrochemical plant.

### DETAILED DESCRIPTION

The following discussion relates to systems and methods for (e.g., actively and continuously) optimizing an operation of an electrochemical system or a plurality of electrochemical systems of an electrochemical plant and/or facility. The disclosure advantageously describes a system configured to optimize an operation an electrochemical system based on a desired performance parameter. Additionally, the disclosure advantageously provides a system with machine-learned models that may be continuously or repeatedly updated based on operating load points and operating conditions of the electrochemical system, e.g., received in real-time, to adjust one or more setpoints for the operation of the electrochemical system.

Furthermore, the disclosure advantageously provides a system that optimizes an electrochemical plant having at least one electrochemical system. For instance, in large electrolysis facilities configured to produce at least 10 tons of hydrogen gas per day, in which power costs are a significant concern, the system advantageously optimizes the operation of the electrochemical facility. The system considers various factors, including hydrogen crossover, maintenance schedules, component degradation, future demand, electricity supply, storage usage, power conversion efficiency, the health of system components, or combinations thereof. Additionally, when multiple electrolysis plants share the same electrical feed or power source, the plants can communicate to further optimize operations collaboratively.

The disclosure further advantageously describes a system configured to monitor and optimize an operation of an electrochemical stack of a system based on desired operating set points.

Additionally, the disclosure advantageously provides a system with machine-learned models that may be continuously or repeatedly updated based on operating conditions of the electrochemical system, e.g., received in real-time, to adjust one or more setpoints for the operation of the electrochemical stack.

The disclosure also advantageously provides systems and methods that monitor and optimize an electrochemical stack of the electrochemical system to deliver hydrogen to an end user at a constant/desired pressure.

Additionally, the disclosure advantageously provides systems and methods that optimize an electrochemical stack of the electrochemical system to deliver hydrogen at various consumption profiles and to provide stability at the point of delivery to a customer.

### Electrochemical Cells and Stacks

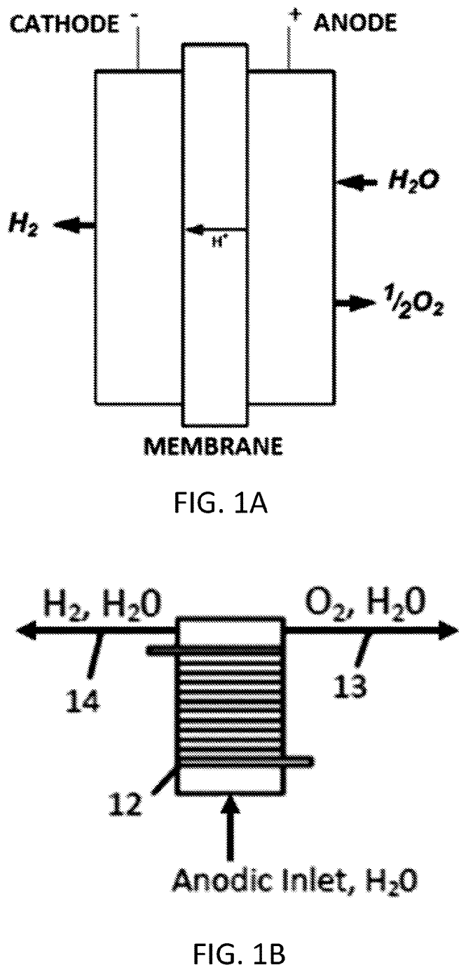

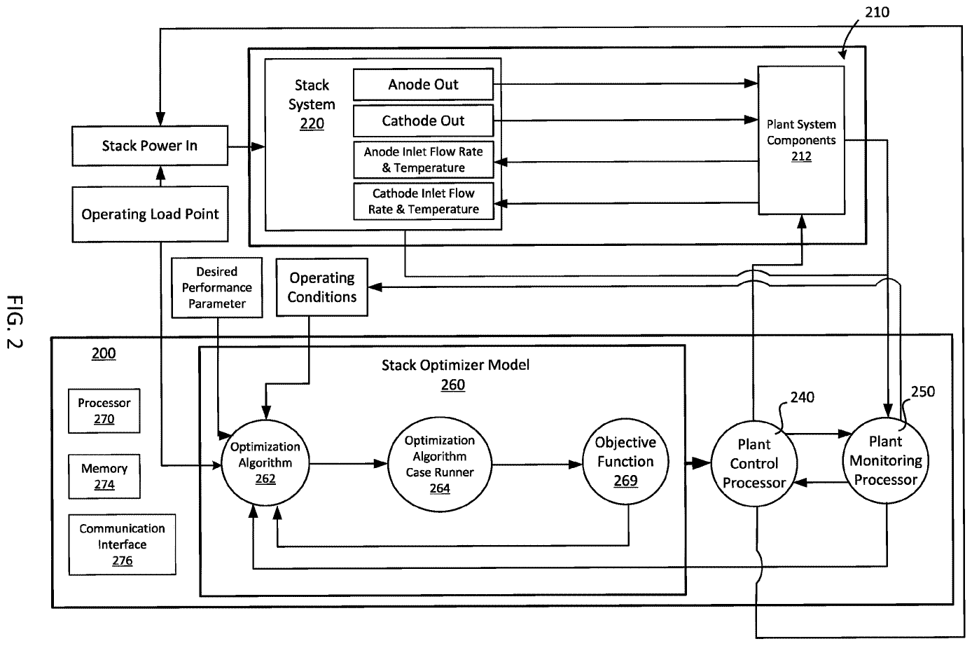

FIG. 1A depicts an example of an electrochemical cell for the production of hydrogen gas and oxygen gas through the splitting of water. The electrochemical cell includes a cathode, an anode, and a membrane positioned between the cathode and anode. Within the water-splitting electrolysis reaction, one interface runs an oxygen evolution reaction (OER) while the other interface runs a hydrogen evolution reaction (HER). For example, the anode reaction is H₂O→2H⁺+½O₂+2e and the cathode reaction is 2H⁺+2e⁻→H₂. The water electrolysis reaction has recently assumed great importance and renewed attention as a potential foundation for a decarbonized “hydrogen economy.”

FIG. 1B depicts an example of an electrochemical system including an electrolyzer or electrochemical stack having a plurality of electrochemical cells of FIG. 1A. In certain examples, the electrolyzer or electrochemical stack may contain 50-1000 cells, 50-100 cells, 500-700 cells, or more than 1000 cells. Any number of cells may make up a stack. The electrochemical cells within the electrochemical stack may be configured to operate with 200 mV or less of pure resistive loss when operating at a high current density.

As described herein, “high current density” may refer to a current density of at least 3 Amps/cm², at least 4 Amps/cm², at least 5 Amps/cm², at least 6 Amps/cm², at least 7 Amps/cm², at least 8 Amps/cm², at least 9 Amps/cm², at least 10 Amps/cm², at least 11 Amps/cm², at least 12 Amps/cm², at least 13 Amps/cm², at least 14 Amps/cm², at least 15 Amps/cm², at least 16 Amps/cm², at least 17 Amps/cm², at least 18 Amps/cm², at least 19 Amps/cm², at least 20 Amps/cm², at least 25 Amps/cm², at least 30 Amps/cm², in a range of 1-30 Amps/cm², in a range of 3-20 Amps/cm², in a range of 3-15 Amps/cm², in a range of 3-10 Amps/cm², or in a range of 10-20 Amps/cm².

Furthermore, the electrochemical cells within the electrochemical stack may be configured to operate at a variable hydrogen production mode or constant hydrogen production mode and at a high cell current density when operating at a defined pressure greater than or equal to atmospheric pressure (e.g., at least 1.1 atm, at least 2 atm, at least 3 atm, at least 4 atm, at least 5 atm, at least 6 atm, at least 7 atm, at least 8 atm, at least 9 atm, at least 10 atm, at least 11 atm, at least 12 atm, at least 13 atm, at least 14 atm, at least 15 atm, at least 16 atm, at least 17 atm, at least 18 atm, at least 19 atm, at least 20 atm, at least 25 atm, at least 30 atm, at least 35 atm, at least 40 atm, in a range of 1-40 atm, in a range of 3-20 atm, in a range of 3-15 atm, in a range of 3-10 atm, or in range of 10-20 atm).

In certain examples, at least two electrochemical stacks may be connected to a same power source and may be configured to operate in a range of 1000 mv to 3000 mv when operating at a high cell current density.

In certain examples, at least two electrochemical stacks may be connected to a same power source and may be configured to operate at a constant hydrogen production mode when operating at a high cell current density. As defined herein, a constant hydrogen production mode refers to an operational state in hydrogen production processes, particularly in electrolysis. In this mode, the hydrogen production rate remains consistent or steady over a period of time.

In certain examples, at least two electrochemical stacks may be connected to a same power source and operating at a constant hydrogen production mode at a constant hydrogen output pressure in a range of 2-40 atm when operating at a high cell current density.

In certain examples, at least two electrochemical stacks may be connected to a same power source and operating at a constant or variable hydrogen production mode at a constant hydrogen output pressure in a range of 2-40 atm when operating at a high cell current density.

As illustrated in the system of FIG. 1B, water (H₂O) may be supplied to the anodic inlet of an electrolyzer or electrochemical stack 12. In some embodiments, only the anodic inlet of the electrochemical stack 12 may receive water. In these embodiments, the cathode side of the electrochemical stack 12 may not receive water (e.g., a dry cathode side may be used). In another embodiment, a cathode inlet may also receive water, wherein the water may be supplied to the cathode inlet to cool the electrochemical stack 12 during electrolysis.

The water supplied to the anodic inlet flows to an anodic inlet manifold that distributes the water to the anode side of the plurality of cells contained with the electrochemical stack 12. In embodiments where water is supplied to the cathode inlet, water supplied to the cathode inlet flows to a cathodic inlet manifold that distributes the water to the cathode side of the plurality of cells in the electrochemical stack 12. In certain examples, the amount of water (e.g., deionized (DI) water) transferred to or circulated through each cell of the electrochemical stack 12 may be less than 5 mL/Amp/cell/min, less than 1 ml/Amp/cell/min, less than 0.5 mL/Amp/cell/min, less than 0.1 ml/Amp/cell/min, less than 0.05 ml/Amp/cell/min. In other examples, the amount of water transferred to or circulated through each cell of the stack may be in a range of 0.05-0.1 mL/Amp/cell/min, 0.05-0.25 mL/Amp/cell/min, 0.05-0.5 mL/Amp/cell/min, 0.05-1 mL/Amp/cell/min, 0.05-5 mL/Amp/cell/min, 0.1-1 mL/Amp/cell/min, 0.1-5 mL/Amp/cell/min, 0.25-1 mL/Amp/cell/min, in a range of 0.25-5 ml/Amp/cell/min, or in a range of 0.5-1 mL/Amp/cell/min.

During electrolysis, oxygen (O₂) is produced at the anode side of the electrolytic cells and hydrogen (H₂) is produced at the cathode side of the electrolytic cells. Specifically, a water splitting electrolysis reaction is configured to take place within each individual cell in the cell stack 12. Each cell includes one interface (the anode side of the cell) configured to run an oxygen evolution reaction (OER) and another interface (the cathode side of the cell) configured to run a hydrogen evolution reaction (HER), such as depicted in FIG. 1A.

Although not illustrated in FIG. 1B, an electrochemical system may further include a plurality of electrochemical components used to operate the electrochemical system. Such components may include pumps, heat exchangers, AC to DC rectifiers, chillers, dry coolers, valves, sensors, and various other elements crucial for maintaining optimal functionality and efficiency.

For example, power supply units within the power supply modules may be connected to and receive energy from the power grid or a renewable energy power source (e.g., a solar plant, windfarm, fuel cell array). In certain examples, each power supply module and the plurality of power supply units within the power supply modules may be connected to a single input source of power.

The power supply modules may further include one or more medium voltage transformers rated in a range of 1-70 kV and one or more AC-to-DC power converters. For example, the transformers may be configured to convert 6.25 MW of 34.5 kV AC to 820 V AC to feed the AC-to-DC power converters. The power converters may then transfer DC power through busbars to the electrochemical stack section.

In various implementations, the power supply modules may further include a rectifier and/or inductor to support adaptation of power from the power grid and provide power to a plurality of electrochemical stacks connected in series.

These supplementary electrochemical components play a pivotal role in regulating the system's internal conditions, ensuring the appropriate flow of reactants, managing thermal considerations, and monitoring crucial parameters. For instance, pumps facilitate the movement of fluids within the system, heat exchangers regulate temperature, valves control the flow of substances, and sensors provide real-time data to enable precise system control.

The electrochemical cells and stacks discussed within FIGS. 1A and 1B may be incorporated into an electrochemical plant having one or more electrochemical stacks (e.g., a plurality of electrochemical stacks).

The one or more electrochemical stacks may be incorporated within a large-scale electrochemical plant configured to generate at least 1,000 kg/day, at least 5,000 kg/day, or at least 10,000 kg/day of hydrogen gas, e.g., via continuous operation of the plant. In certain examples, the hydrogen gas generated in the electrochemical stacks may be aggregated and supplied to an end user/customer with a purity of at least 98% at a pressure of at least 20 atm.

In other embodiments, the one or more electrochemical stacks within the electrochemical plant may be configured to consume at least 10 megawatts (MW) of power per day for the production of hydrogen gas, or in other embodiments, at least 25 MW, at least 50 MW, at least 75 MW, at least 100 MW, 10-100 MW, 25-100 MW, or 50-100 MW of power per day.

Optimizing the operation of an electrochemical system is a multifaceted endeavor, crucial for efficiency and sustainability. Therefore, methods and systems are desired to operate the electrochemical system at the most efficient point possible at a set load point.

Certain proposed systems and methods disclosed herein aim to advantageously use real-time data collection and historical analysis for the development of optimization models that encapsulate the intricate relationships between input parameters like electricity, temperature, and pressure, and desired outputs such as hydrogen production and equipment longevity. Additional proposed systems and methods disclosed herein aim to advantageously enhance the efficiency, reliability, and adaptability of electrochemical systems within industrial settings. By leveraging technologies such as machine learning and real-time data analysis, these systems offer several benefits.

Additionally, by defining clear optimization objectives and employing optimization models, the disclosed system and method may advantageously adjust operating parameters dynamically, ensuring minimal electricity usage, prolonged equipment life, and precise hydrogen delivery to customers.

Certain proposed systems and methods disclosed herein advantageously, through real-time monitoring of operating conditions, ensure stable and consistent delivery of hydrogen to end-users, meeting desired pressure requirements regardless of fluctuations in demand or environmental factors.

Furthermore, certain disclosed systems and methods may advantageously integrate load balancing, predictive maintenance, and hydrogen demand prediction to refine the operation of the electrochemical system, while considering energy cost dynamics and environmental impact.

Certain systems and methods proposed herein also offer advantageous adaptability through the integration of machine-learned models, enabling dynamic responses to evolving operating conditions, consumption profiles, and customer demands. This ensures seamless operation across diverse scenarios. Moreover, by consistently delivering hydrogen at desired pressure levels and accommodating various consumption patterns, these systems and methods significantly boost customer satisfaction, guaranteeing dependable, and uninterrupted service.

Additionally, certain proposed systems and methods disclosed herein advantageously, through optimized operation and enhanced efficiency, reduce operational costs associated with energy consumption, maintenance, and downtime, resulting in long-term economic benefits for plant operators.

As a result, the proposed systems and methods disclosed herein aim to advantageously optimize the operation of an electrochemical system or a plurality of electrochemical systems of an electrochemical plant and/or facility, or achieve higher levels of performance, resilience, and cost-effectiveness, with a respect to operation of an electrochemical system.

### Electrochemical Optimization Systems-Adjusting One or More Setpoints for the Operation of the Electrochemical System Based on an Optimization Model

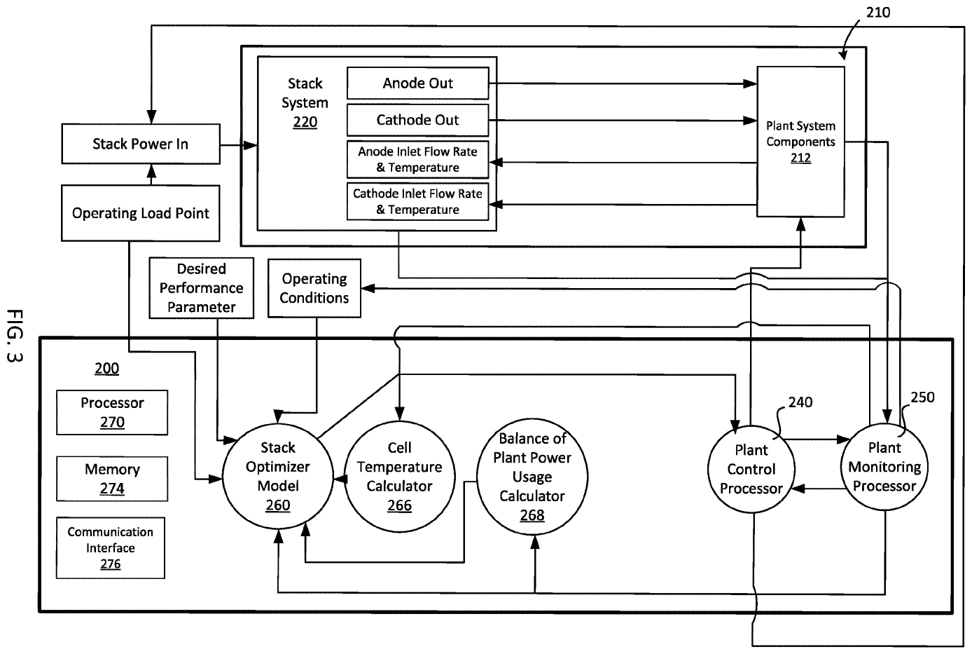

FIG. 2 depicts an embodiment of an electrochemical optimization system 200 for an electrochemical plant 210 (i.e., plant) having at least one electrochemical system 220 (i.e., stack system). In this depicted example, only one electrochemical system 220 is depicted and controlled by the electrochemical optimization system 200. However, the electrochemical plant 210 may have any number of electrochemical systems or electrochemical stacks and is not limited to a single electrochemical system or single stack. The electrochemical system 220 may be the electrochemical system described in FIG. 1B. Furthermore, as mentioned above, an electrochemical system may include a plurality of electrochemical stacks (i.e., stacks).

The electrochemical optimization system 200 is configured to optimize the operation of the electrochemical plant 210 containing the electrochemical system 220. In this depicted example, since the plant 210 has only one electrochemical system 220, the electrochemical optimization system 200 is configured to control and optimize the operation of the electrochemical system 220 (i.e., stack system) based on an optimization model generated by an electrochemical optimizer model 260, wherein the optimization model models the operation of the electrochemical plant 210.

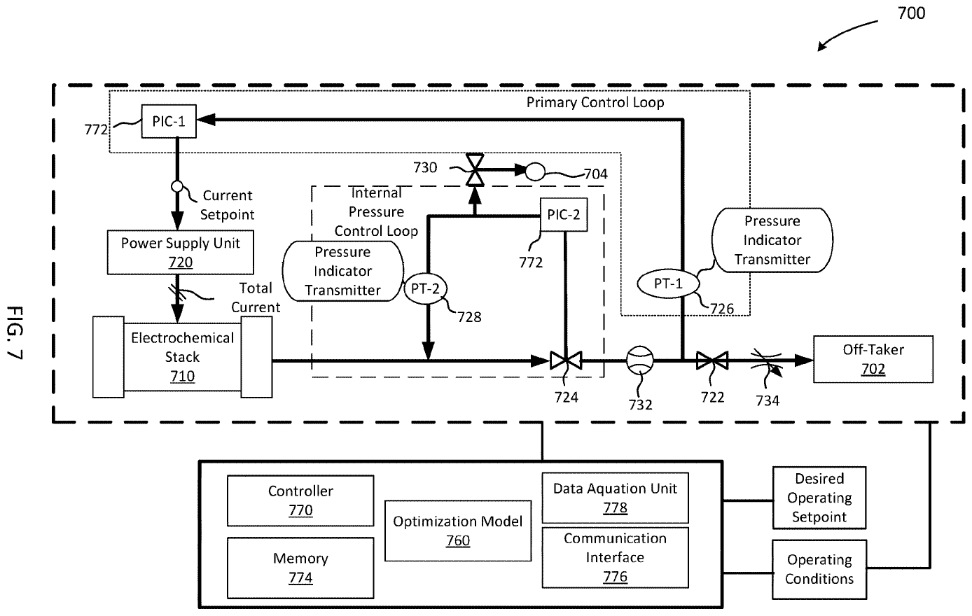

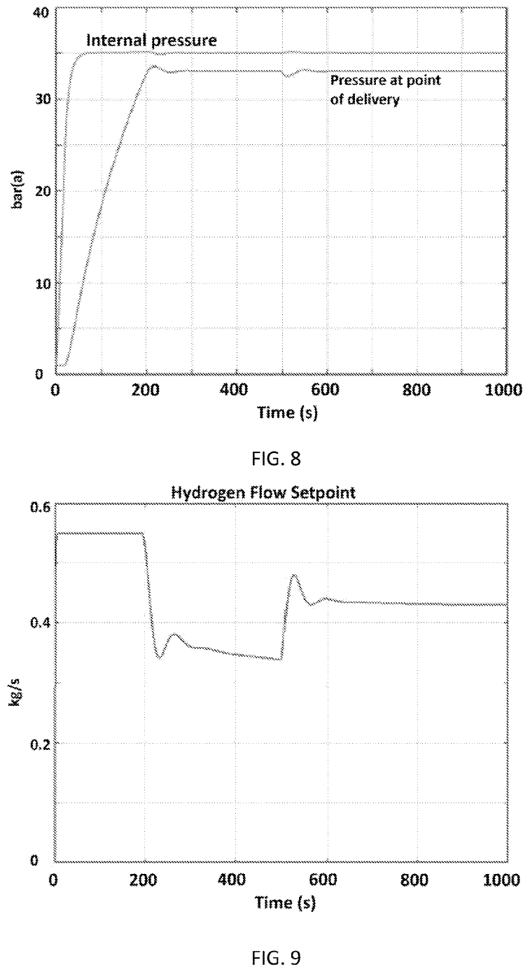

As depicted in FIG. 2, the electrochemical optimization system 200 includes at least one processor 270, at least one memory 274, and a communication interface 276 (e.g., a graphical user interface), which are described further below with respect to FIG. 8.

The electrochemical system 220 also includes at least one electrochemical plant control processor 240, at least one plant monitor processor 250 (e.g., a data acquisition unit), and a stack optimizer model 260, which may be implemented using the at least one processor 270 and/or memory 274. The system 200 may be incorporated as one system with one or more processors within the system 200. In another embodiment, however, the system 200 may incorporate separate and distinct sub-systems having separate processors.

The memory 274 may store one or more sets of rules, algorithms, or optimization models generated by the stack optimizer model 260 for controlling the electrochemical plant 210. The processor 270 may implement or execute the one or more sets of rules, algorithms, or optimization models via the plant control processor 240. In other words, the processor 270 may transmit the one or more set of rules, algorithms, or optimization models to the plant control processor 240 such that the plant control processor 240 adjusts one or more setpoints for the operation of the electrochemical system 220 based on the optimization model.

The plant control processor 240 is configured to control the plant 210 based on parameters defined in an optimization model generated by the stack optimizer model 260 (described further below).

In this depicted example, since the plant 210 has only one electrochemical system 220, the plant control processor 240 controls the plant parameters pertaining to the electrochemical system 220. However, if the plant 210 includes a plurality of electrochemical systems 220, the plant control processor 240 may control the parameters for each of the electrochemical systems of the plant 210 to advantageously control the entire plant 210.

For example, the plant control processor 240 may control the components 212 of the electrochemical system 220 such as pumps to facilitate the movement of fluids within the plant, heat exchangers configured to regulate temperatures, valves configured to control the flow of substances, and sensors configured to provide real-time data to enable precise system control. The plant control processor 240 may control the components 212 to adjust the parameters of the electrochemical system 220.

The plant monitoring processor 250 is configured to monitor the plant performance and the health of the plant 210. As mentioned above, the electrochemical plant 210 includes plant system components 212 such as pumps to facilitate the movement of fluids within the plant 210, heat exchangers configured to regulate temperature, valves configured to control the flow of fluids, and sensors configured to provide real-time data to enable precise system control. The plant monitoring processor 250 is configured to systematically capture and analyze the operating conditions of the plant 210 including the plant system components 212.

The operating conditions of the plant 210 may include real-time operating data of the plant 210 and ambient operating conditions of the plant 210. The real-time operating data may include the power usage of the plant system components 212. Additionally, the real-time operating data may include the fluid flow rates, temperature levels, pressure conditions, and sensor feedback of the plant 210. These parameters serve as critical indicators of the plant's operational state.

Real-time data refers to the capability of a system to respond or provide results instantly or with minimal delay. In other words, data is processed, or events are handled as they occur, without significant delay.

In this depicted example, the plant monitoring processor 250 monitors the performance and health of the electrochemical system 220. For example, the plant monitoring processor 250 is configured to monitor the performance of the stack within the electrochemical system 220 and the components of the electrochemical system 220. The plant monitoring processor 250 systematically captures and analyzes crucial parameters from the stack of the electrochemical system 220 such as the fluid flow rates, temperature levels, and pressure conditions at the anode and cathode inlets and outlets of the stack. The received parameters may be transmitted by the plant monitoring processor 250 to be stored in the memory 274 as data records, transmitted to the stack optimizer model 260 for training and analysis, and transmitted to the plant control processor 240 to control or adjust the parameters of the plant 210 accordingly.

Additionally, the plant control processor 240 may transmit the adjusted plant parameters to the plant monitoring processor 250. The plant monitoring processor 250 may advantageously check whether parameters such as temperature, pressure, flow rates, and other critical variables align with the setpoints and operational thresholds set by the plant control processor 240. In the event of any deviations, the plant monitoring processor 250 is configured to generate real-time alerts or notifications.

Referring back to FIG. 2, the stack optimizer model 260 is designed to generate an optimization model that considers desired performance parameters, operational load points of the electrochemical system 220 within the plant 210, and/or the operating conditions of the electrochemical system 220. The plant control processor 240 of the system 200 may be configured to adjust one or more setpoints for the operation of the electrochemical system 220 of the plant 210 based on the optimization model.

To generate the optimization model, the stack optimizer model 260 may be a machine-learned model that is trained using data obtained from the plant system 210. This data may include real-time and/or historical information on the operation of the electrochemical system 220 within the plant 210. Additionally, or alternatively, the machine-learned model may be trained with data obtained from one or more additional electrochemical systems separate from the plant 210.

The stack optimizer model 260 may be a genetic algorithm, simulated annealing, local minimization, evolutionary algorithm, gradient descent, branch and bound, differential algorithm, hill climbing, or any other algorithm capable of identifying minimums in complex objective functions. Multiple algorithms may be utilized concurrently if deemed necessary. The execution of these algorithms or control functions is managed by the system 200, which governs the overall operation of the plant.

In some examples, the stack optimizer model 260 may include an optimization algorithm 262, an optimization algorithm case runner 264, and/or an objective function 269, as depicted in FIG. 2.

The optimization algorithm 262 receives the desired performance parameter, the operating load point of the electrochemical system 220 of the plant 210, and/or the operating conditions of the electrochemical system 220 of the plant 210. The optimization algorithm 262 may run at regular intervals, periodically assessing and adjusting the electrochemical system's 220 parameters. This periodicity allows for continuous monitoring and improvement.

The operating load points of the stack of the electrochemical system 220 and the operating conditions of the electrochemical system 220 may be received via the plant monitoring processor 250. The desired performance parameter may be received from a user input via the communication interface 276.

Table 1, depicted below, summarizes a non-limiting list of potential desired performance parameters (i.e., Objective Function Targets), and operating load points of the electrochemical system 220 of the plant 210 and operating conditions of the electrochemical system 220 of the plant 210 (i.e., Inputs to Optimization). Table 1 also includes a non-limiting list of potential setpoints (i.e., Outputs of Objective Function) for the operation of the electrochemical system 220 of the plant 210.

TABLE 1

| Inputs To Optimization | Objective Function Targets | Outputs Of Objective Function |
|---|---|---|
| Current Hydrogen Demand | Maximizing H₂ Out | Stack Power Levels |
| Future Hydrogen Demand | Minimizing Electricity Usage | Fluid Flow Rates |
| Hydrogen Storage System | Maximizing Profit or Profit | Cooling System(S) Operating |
| Available Volume & Total | Margin | Level |
| Capacity | | |
| Current Electricity Demand | Stack Temperature | Control Valve Position |
| Future Electricity Demand | Specific O&M Service Windows | RODI System Production Rate |
| Electricity Storage System | Minimizing O&M Services | Plant Power Levels |
| Status | | |
| Operations And Maintenance | Maximizing Component/ | Hydrogen Production Rate Plan |
| Schedule | System/ Plant Lifetime | |
| System Efficiency & | Minimizing Hydrogen Crossover | Power Usage Plan |
| Performance Maps | | |
| Electricity Pricing | | Operating Temperature Targets |
| Hydrogen Pricing | | |
| Gas Detector Readings | | |
| Status Of Other Hydrogen | | |
| Plants | | |
| The Current Health Of | | |
| Components/ Systems/ Plant | | |
| Temperatures In The System | | |
| Pressures In The System | | |
| Flow Rates In The System | | |
| Stack Voltages | | |
| Plant General Operating Data | | |
| Water Quality | | |

Table 2, depicted below, further summarizes a non-limiting list of potential setpoints (i.e., Outputs of Objective Function) for the operation of the electrochemical system 220 of the plant 210. For instance, various optimizations can be achieved using a combination of the following plant process/control parameters listed in Table 2 below.

TABLE 2
Outputs Of Objective Function

| | | |
|---|---|---|
| Anode Inlet Temp | Rectifier Output Voltage | H₂ Detection At Anode Out |
| | | Manifold |
| Anode Inlet Flow | Rectifier Output Current | H₂ Detection At Anode |
| | | Separator |
| Cathode Inlet Temp | Rectifier Input Voltage | Make-Up Water Tank Level, |
| | | Pressure, and Flow Rate |
| Cathode Inlet Flow | Rectifier Input Current | Water Temperature Dry Cooler |
| | | In |
| Anode Pressure | Anode Water Flow | Water Temperature Dry Cooler |
| | | Out |
| Cathode Pressure | Cathode Water Flow | Water Flowrate Dry Cooler In |
| Pressure At the Anode | Flow Rate At Anode Separator | Water Flowrate Cooler Out |
| Separator | | |
| Pressure At the Cathode | Flow Rate At Cathode | Reverse Osmosis/Deionization |
| Separator | Separator | (RO/DI) Water Inlet Temp |
| Stack Voltage Monitoring | Water Conductivity at the | Reverse Osmosis/Deionization |
| System | Anode Outlet | (RO/DI) Water Outlet Temp |
| H₂ Output Volume, Flowrate, | Water Temperature Into | Reverse Osmosis/Deionization |
| Temp, Purity, and Pressure | Chiller | (RO/DI) Inlet And Outlet Water |
| | | Conductivity |
| Renewable Power Availability | Rectifier Cooler Inlet/Outlet | Water Conductivity Anode Inlet |
| | Temperature | |
| Pump Health | Sensor Health | |

In some examples, the desired performance parameters (i.e., objective function targets) for the operation of the plant 210 may include a maximized H₂ output, a minimized electricity usage, a minimized operating cost, a maximized profit, a maximized profit margin, a set stack temperature, a set output pressure, a hydrogen crossover limit, a maximized lifetime of the electrochemical system 220, a maximized lifetime of the components of the electrochemical system 220, or a combination thereof.

In some examples, the operating load points (i.e., inputs to optimization) of the plant 210 may include information pertaining to load limits of the stack of the electrochemical system 220 of the plant 210. For example, these load limits could pertain to various operational aspects, such as current, voltage, temperature, and other relevant parameters associated with the stack of the electrochemical system 220. This information may delineate the maximum permissible load that the electrochemical system 220 can sustain under different conditions, ensuring that the stack operates within specified safety and efficiency parameters. Additionally, these load points provide crucial insights for optimizing the electrochemical system's performance, allowing for precise control and management of the stack's operational characteristics.

In some examples, the operating conditions of the plant 210 may include real-time operating data of the plant 210 and ambient operating conditions of the plant 210. For example, the operating conditions of the plant 210 may be received from the plant monitoring processor 250. The real-time operating data may include variables such as current flow, voltage levels, temperature profiles, and pressures within the plant 210. These parameters provide a dynamic snapshot of the plant's instantaneous performance, allowing for prompt adjustments and interventions to optimize efficiency and maintain operational stability.

Simultaneously, ambient operating conditions capture external factors that influence the plant 210 (i.e., the stack system 220), such as ambient temperature, humidity, and atmospheric pressure.

As mentioned above, the optimization model generated by stack optimizer model 260 determines adjustments to one or more setpoints for the operation of the plant 210 (i.e., the electrochemical system 220 in this depicted example). In some examples, the setpoints (i.e., outputs of objective function) for the operation of the plant 210 include the stack power level and the overall electrochemical system's 220 power level, influencing the electrical output of the plant 210. Additionally, control extends to fluid flow rates within the electrochemical system 220, ensuring optimal circulation of fluid within the electrochemical system 220. For instance, the operating level of a cooling system (not illustrated) of the electrochemical system 220 is a key setpoint, guiding adjustments to maintain suitable temperatures across components of the electrochemical system 220, while minimizing electrical consumption. Additionally, control valves, with their positions as setpoints, play a role in regulating fluid and gas flows, impacting the electrochemical system's 220 pressure and temperature. Other significant setpoints involve the hydrogen production rate, power usage rate, stack temperature, stack output pressure, rectifier voltage and current, anode separator flow rates, cathode separator flow rates, and the like, each crucial for the efficient and reliable functioning of the electrochemical system 220. The flexibility to adjust these setpoints individually or in combination advantageously optimizes the performance of the electrochemical system 220 based on the desired performance parameters.

Referring back to FIG. 2, the optimization algorithm 262 is configured to generate one or more simulations including one or more respective adjustments to the one or more setpoints for the operation of the plant 210, based on the received desired performance parameter, the operating load point of the electrochemical system 220 of the plant 210, and the operating conditions of the electrochemical system 220 of the plant 210.

Additionally, the optimization algorithm 262 may be configured to determine: (1) the predicted temperature data of the stack of the electrochemical system 220; and/or (2) the predicted balance of plant power usage data of the electrochemical system 220 based on the respective simulations.

In other words, for a specific load point of the electrochemical stack of the electrochemical system 220, the system 200 operates the plant 210 to achieve the highest efficiency point that is feasible. This involves operating the stack temperature as close to maximum operating temperature as possible while minimizing plant power usage.

For example, efficiency is heavily based on stack temperature with the goal of running the stack as hot as possible without damaging the membrane of the stack. However, temperature within an electrochemical cell of an electrochemical stack, the temperature within a sub-stack having a plurality of electrochemical cells of the stack, or the temperature within the stack itself of the electrochemical system 220 may not be easily measured. As a result, one or more of the operating temperatures within the stack of the electrochemical system 220 may be predicted based on the simulations. The predicted temperature of the stack may be validated and adjusted based on data collected from the operation of the stack, and input as a factor in determining the optimization model.

Additionally, the balance of plant power usage data of the electrochemical system 220 may also be predicted based on the simulations. The balance of plant power usage data refers to the data collected pertaining to the power used by the plant system components 212 (i.e., the components of the electrochemical system 220). For example, the plant system components 212, contribute to the overall energy requirements of the electrochemical system 220. Predicting the power consumption of pumps, compressors, and other auxiliary devices ensures a comprehensive understanding of the electrochemical system's 220 energy dynamics. As a result, the predicted balance of plant power usage data of the electrochemical system 220 is also input as a factor in determining the optimization model.

Referring back to FIG. 2, the stack optimizer model 260 may further include an algorithm case runner 262 and/or an objective function 269.

The simulations generated by the optimization algorithm 262 may be transmitted to an optimization algorithm case runner 264. The optimization algorithm case runner 264 may be configured to run the individual simulations generated by the optimization algorithm 262.

The objective function 269 may be configured to score each simulation of the one or more simulations to identify an optimal adjustment to the one or more setpoints for the operation of the electrochemical system 220 of the plant 210. The optimal adjustment may be provided as an input to the optimization model for determining the adjustment to the one or more setpoints for the operation of the electrochemical system. For example, the highest scored simulation of a plurality of simulations may be identified as the optimal adjustment to the setpoints for the operations of the electrochemical system 220 of the plant 210.

FIG. 3 depicts an additional embodiment of an electrochemical optimization system 200 for an electrochemical plant 210 (i.e., plant) having at least one electrochemical system 220 (i.e., stack system).

In this depicted example, the electrochemical system 220 also includes a cell temperature calculator 266 and a balance of plant power usage calculator 268 in addition to the electrochemical plant control processor 240, the plant monitor processor 250, and the stack optimizer model 260.

The cell temperature calculator 266 may be configured to determine the predicted temperature data of one or more cells, sub-stack of cells, and/or stack of cells within the electrochemical system 220 based on the collected real-time operating data of the electrochemical system 220. The cell temperature calculator 266 may be a machine-learned model trained using data obtained from the real-time operating data of the electrochemical system 220. In this depicted example, the model may be a 1D computational model but is not limited to just being a 1D model. The predicted temperature data of the stack of the electrochemical system 220 may also be continuously updated based on the received real-time operating data from the plant monitoring processor 250.

For example, historical data, received from the memory 274, may be used to predict the temperature data of the electrochemical stack. Historical data may include previously collected operating data of the stack and the electrochemical system 220. Additionally, the cell temperature calculator 266 may receive from the plant monitoring processor 250, real-time operating data of the stack of the electrochemical system 220, and/or the overall electrochemical system 220, to continuously update and adjust the predicted temperature data. As a result, the cell temperature calculator 266 may advantageously provide accurate predicted temperature data of the stack of the electrochemical system 220 by being trained from the collected real-time operating data of the electrochemical system 220.

The balance of plant power usage data calculator 268 may be configured to determine the predicted balance of plant power usage data of the electrochemical system 220 based on the collected real-time operating data of the electrochemical system. The balance of plant power usage data calculator 268 may be a machine-learned model trained using data obtained from the real-time operating data of the electrochemical system 220. In this depicted example, the model may be a 1D computational model but is not limited to just being a 1D model.

For example, historical data, received from the memory 274, may be used to predict the balance of plant power usage data of the electrochemical system 220. Historical data may include previously collected operating data of the components 212 of the electrochemical system 220. Additionally, the balance of plant power usage calculator 268 may receive real-time operating data of the components 212 of the electrochemical system 220 from the plant monitoring processor 250, to continuously update and adjust the balance of plant power usage data. As a result, the cell temperature calculator 266 may advantageously provide accurate predicted balance of plant power usage data of the electrochemical system 220 by being trained from the collected real-time operating data of the electrochemical system 220.

The system 200 described in the embodiments above advantageously leverages machine learning algorithms to optimize various aspects of the plant's 210 operation. These algorithms play a pivotal role in maximizing hydrogen output by considering input cost functions such as renewable power availability, power cost rates, and time of day functions. Simultaneously, as mentioned above, machine learning is applied to monitor the health of electrolyzer stacks and optimize multiple trains, each comprising different combinations of electrolyzer and power supply, running in various modes. Furthermore, the system 200 advantageously may switch or adjust based on different desired parameters within milliseconds, ensuring adaptability to changing conditions.

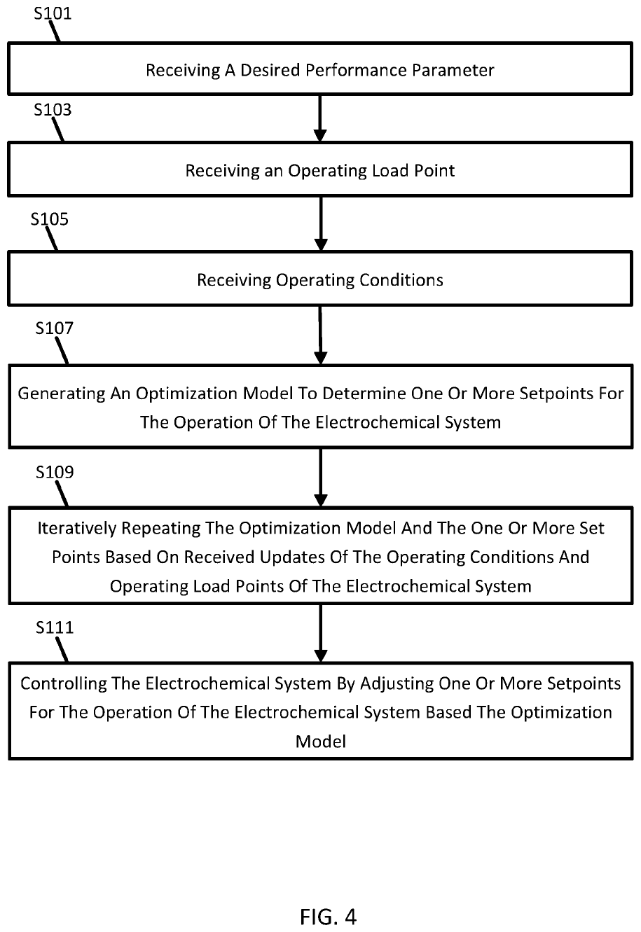

FIG. 4 depicts a flowchart describing a method for optimizing an operation of an electrochemical system of a plant using one of the embodiments of an electrochemical optimization system described above.

In act S101, the stack optimizer model 260 of the system 200 receives a desired performance parameter, via the communication interface 276, for the operation of the electrochemical system 220. For instance, stack optimizer model 260 may receive a maximized H₂ output, a minimized electricity usage, a minimized operating cost, a maximized profit, a maximized profit margin, a set stack temperature, a set output pressure, a hydrogen crossover limit, a maximized lifetime of the electrochemical system or a component thereof, or a combination thereof.

In act S103, the stack optimizer model 260 also receives an operating load point of the electrochemical system 220, via the plant monitoring processor 250. As mentioned above, the operating load point of the plant 210 may include information pertaining to load limits of the stack of the electrochemical system 220 of the plant 210. These load limits could pertain to various operational aspects, such as current, voltage, temperature, and other relevant parameters associated with the stack of the electrochemical system 220.

In act S105, the stack optimizer model 260 further receives operating conditions of the electrochemical system 220 of the plant 210, via the plant monitoring processor 250. As mentioned above, the operating conditions of the electrochemical system 220 may include real-time operating data of the electrochemical system 220 and ambient operating conditions of the electrochemical system 220. The real-time operating data may include the power usage of the plant system components 212. Additionally, the real-time operating data may include the fluid flow rates, temperature levels, pressure conditions, and sensor feedback of the plant 210.

In act S107, the stack optimizer model 260 generates an optimization model to determine one or more setpoints for the operation of the electrochemical system 220. The optimization model is determined using a learned model. The optimization model takes into account the desired performance parameter, the operating load point of the electrochemical system 220, and the operating conditions of the electrochemical system 220.

In act S109, the optimization model generated by the stack optimizer model 260 is iteratively repeated and one or more setpoints are iteratively adjusted based on received updates of the operating conditions of the electrochemical system and/or received updates of the operating load point of the electrochemical system.

In act S111, the optimization model is transmitted, via the processor 270, to the plant control processor 240. The plant control processor 240 controls the electrochemical system 220 by adjusting the one or more setpoints for the operation of the electrochemical system 220 based on the optimization model.

Described below are various non-limiting examples of the optimization system 200 optimizing the plant 210 based on desired performance parameters and modes.

As mentioned above, the system 200 may optimize the electrochemical plant 210 based on various factors to reach a desired performance parameter. Such not limiting desired parameters include: maximizing H₂ output; minimizing energy usage for a given H₂ output level; maximizing H₂ output considering a set price for hydrogen and cost of electricity and water; minimizing wear and degradation on key plant components; and output pressure-based control. In other words, the system 200 allows flexibility in controlling the operating load point of the stack system 220, considering factors such as available power, plant capacity, hydrogen demand, and any other customer-specific factors.

In one example, when the system 200 receives a desired performance parameter such as maximizing the H₂ output of the plant 210, the system 200 transmits the maximized H₂ output demand, the operating load point, and the operating conditions to the stack optimizer model 260. The stack optimizer model 260 then generates an optimization model for operating the plant 210. Based on the optimization model, the plant controller 240, adjusts one or more setpoints for the operation of the electrochemical system 220 of the plant 210 such that the plant 210 maximizes the output of H₂. In this case, the pressure of the line in the electrochemical system 220 may be varied such that a maximum amount of H₂ is output from the electrochemical system 220. However, if the H₂ demanded is greater than either the available power or plant capacity, then the system 200 runs the operation of the plant 210 in “maximum H₂ output mode” or in an “H₂ output control mode.”

In another example, consider the system 200 receiving a desired performance parameter of minimizing energy usage while achieving a specified hydrogen output level, such as 100 kg of hydrogen out the of plant 210. The system 200 is configured to dynamically optimize the plant's 210 operation, taking into account factors such as temperature, pressure, flow rates, and catalyst efficiency. The system 200 continuously monitors these variables in real-time, making adjustments to the reaction conditions and process parameters to find the most energy-efficient combination for the given H₂ output. In other words, the system 200 may fine-tune temperature and pressure in reforming processes to optimize efficiency. The system 200 operates within a feedback loop, ensuring that the actual energy consumption aligns with the target. By making real-time adjustments based on sensor data and feedback mechanisms, the system 200 optimizes the operation of the plant 210 by minimizing energy usage while consistently meeting the specified H₂ output level.

In another example, consider the system 200 receiving a desired performance parameter of maximizing hydrogen H₂ output while considering economic factors, such as the electric grid bid curve and considering both future and past electrical prices. The system 200 dynamically optimizes the plant's 210 operation, based on an optimization model, factoring in the set price for hydrogen, the costs of electricity, and water. The system 200 continuously assesses real-time market conditions, adjusting operational parameters such as reaction rates, temperature, and pressure to maximize H₂ output while remaining economically efficient. If the market price for hydrogen fluctuates, the control scheme may adapt to capitalize on favorable conditions. The plant operates within a feedback loop, ensuring a continuous assessment of economic performance against the goal of maximizing H₂ output. Real-time adjustments are made to maintain the balance between production efficiency and cost considerations, resulting in a plant that optimizes hydrogen output within the economic constraints of electricity, water costs, and market dynamics.

In yet another example, consider the system 200 receiving a desired performance parameter where the primary objective is to minimize wear and degradation on critical components, ensuring the longevity and reliability of key equipment. The system 200 is configured to monitor critical components, including catalysts, pumps, and valves, in real-time. Based on the operating load point of the electrochemical system 220, and the operating conditions of the electrochemical system 220, an optimization model is generated by the optimizer model 260. Operational adjustments are made based on the optimization model to reduce stress on these components, optimizing flow rates, adjusting temperatures, and maintaining pressure levels within optimal ranges of the electrochemical system 220 of the plant 210. The system 200 operates within a feedback loop, continuously analyzing component performance and making immediate adjustments to minimize wear. By implementing a condition-based maintenance strategy and prioritizing component health, the hydrogen production plant significantly extends the lifespan of critical equipment, reducing maintenance frequency, and ensuring sustained, reliable operation over time.

In yet another example, the system 200 may optimize the operation of the electrochemical stack 220 of the plant 210 by regulating the production of hydrogen based on maintaining a specific output pressure. In this example, the system 200 adjusts the plant's 210 production to ensure that the output pressure in the hydrogen product line remains constant. If the pressure in the product line drops, indicating increased demand or usage, the system 200 adjusts the operation of the plant 210 by producing more hydrogen. Conversely, if the pressure increases, suggesting lower demand or unused hydrogen, the plant 210 reduces its production. This dynamic adjustment of hydrogen production allows the plant 210 to continuously find the optimal operating point to meet the desired demand while efficiently managing resources. The system 200 plays a crucial role in this process, ensuring that the plant 210 adapts in real-time to maintain the desired output pressure and operational efficiency.

The system 200 may also optimize the electrochemical plant 210 based on additional various factors to reach a desired performance parameter. Such non-limiting desired parameters also include: minimizing hydrogen crossover within an electrochemical stack, minimizing electrical consumption in a cooling loop while maximizing hydrogen production, and efficiently maintaining operation of the plant 210.

For example, when a plant 210 contains multiple electrochemical stacks operating at constant voltage, hydrogen crossover may occur within one of the stacks. Hydrogen crossover involves the unintended transfer of hydrogen from one cell to another within the same stack. In this depicted example, the system 200 may optimize the plant 210 by generating an optimization model and adjusting the operating parameters of the plant 210 based on the optimization model. The system 200 adjusts the parameters, such as voltage or current, to mitigate and control the crossover. As a result, the system 200 controls the operation of the plant 210 such that minima or levels are achieved below a predetermined safe threshold for hydrogen crossover. The system 200 advantageously ensures that the hydrogen production process remains efficient, dependable, and within established safety parameters, even when multiple stacks are operating simultaneously.

In yet another example, consider the system 200 optimizing the operation of the plant 210 by minimizing electrical consumption in a cooling system of the plant 210 while maximizing hydrogen production. The system 200 generates an optimization model and uses the optimization model to adjust cooling parameters to ensure effective temperature regulation while simultaneously minimizing energy usage associated with the cooling system. Simultaneously, the system 200 actively enhances the hydrogen production process by optimizing the operating parameters of the electrolyzer stacks.

In yet another example, consider the system 200 optimizing the operation of the plant 210 to provide maintenance without disrupting the overall operation of the plant 210. The system 200 may optimize the plant 210 when isolating at least one stack of the plurality of the stacks in the plant 210. In this depicted example, during scheduled maintenance, Stack 1 can be electrically and fluidically isolated, enabling thorough inspections and repairs. Meanwhile, Stack 2, Stack 3, and so forth, connected to the same power source, continue to generate hydrogen seamlessly. The system 200 may generate an optimization model to run the plant 210 efficiently on the remaining working stacks. The system 200 may then control and adjust the plant based on the optimization model.

The system 200 may also advantageously optimize large electrolysis facilities, particularly those with a capacity of 10 tons per day or more. For example, where power costs become a dominant factor in operational expenses, the system 200 proves especially beneficial. The optimization process takes into meticulous consideration a myriad of factors, ranging from the management of hydrogen crossover within the stack to the scheduling of operations and maintenance. Additionally, it accounts for the degradation of components and systems, anticipates future hydrogen demand and electricity supply, evaluates storage utilization, and examines the efficiency map of the AC to DC power conversion system. Notably, the approach extends beyond individual plant considerations, envisioning communication and coordination between multiple electrolysis plants operating on the same electrical feed or serving a single off-taker. This collaborative communication aims to further refine and enhance overall operational efficiency in a holistic manner.

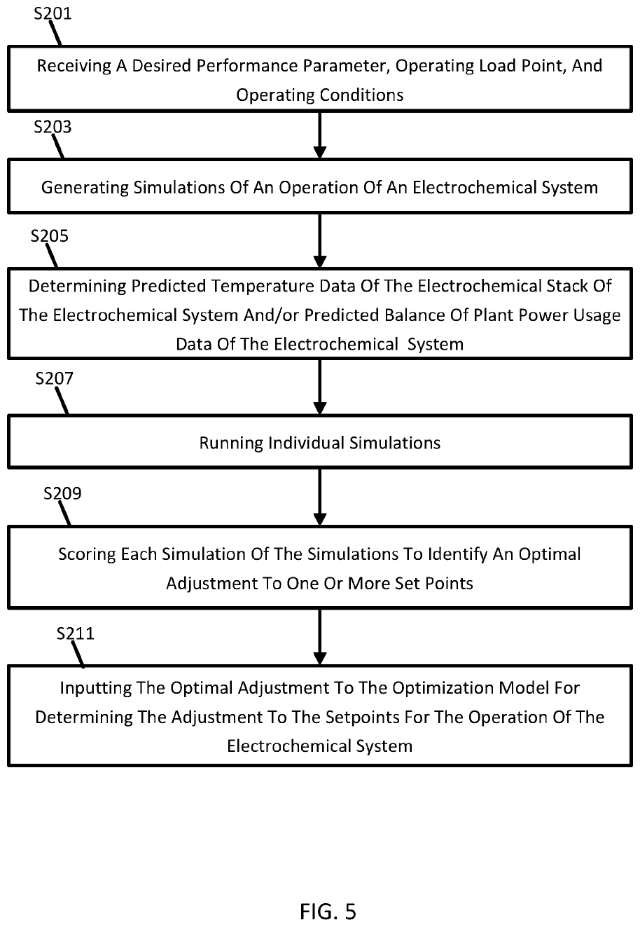

FIG. 5 depicts a flowchart describing a method for generating an optimization model for adjusting an operation of a stack system according to the first embodiment of the present disclosure.

In act S201, the optimization algorithm 262 of the stack optimizer 260 receives a desired performance parameter of the performance parameters, an operating load point of the stack system 220 of the plant 210, and operating conditions of the stack system 220 of the plant 210.

In act S203, the optimization algorithm 262 generates simulations of the operation of the stack system 220 based on the received desired performance parameter, the operating load point of the stack system 220, and the operating conditions of the stack system 220. For instance, the optimization algorithm 262 generates simulations for one or more respective adjustments to the one or more setpoints for the operation of the stack system 220, simulations for predicted temperature data, and simulations for predicted balance of plant power usage data.

In act S205, the optimization algorithm 262 determines predicted temperature data of the electrochemical stack of the stack system 220 and/or predicted balance of plant power usage data of the stack system 220 based on the respective generated simulations.

In act S207, the optimization algorithm case runner 264 runs the individual simulations generated by the optimization algorithm 262.

In act S209, the objective function 269 of the stack optimizer model 260 scores each simulation of the one or more simulations to identify an optimal adjustment to the one or more set points.

In act S211, the optimal adjustment is provided as an input to the optimization model for determining the adjustment to the one or more setpoints for the operation of the electrochemical system 220 of the plant 210.

For example, with the receipt of inputs in act S201, the optimization algorithm 262 sets its sights on achieving a 100 kW power output by considering the plant's current load point at 80% capacity, along with ambient conditions such as a temperature of 25° C. and a hydrogen supply pressure of 50 atm. Moving on to act S203, simulations are generated, tweaking setpoints like hydrogen and air flow rates, as well as the operating temperature of the fuel cell stack. These simulations encompass predictions for temperature and balance of plant power usage. Subsequently, at act S205, the optimization algorithm 262 determined predicted temperature and power usage data based on the simulations. In Act S207, these simulations are executed by the case runner 264. The objective function 269 then steps in during act S209, scoring each simulation against the desired 100 kW power output. Finally, act S211 concludes the process by utilizing the optimal adjustment, determined in act S209, as input to the optimization model, thereby refining the setpoints for the electrochemical system's 220 operation within the power plant 210. This iterative and systematic approach ensures the fuel cell system operates at peak efficiency while adapting to specific plant conditions and load points.

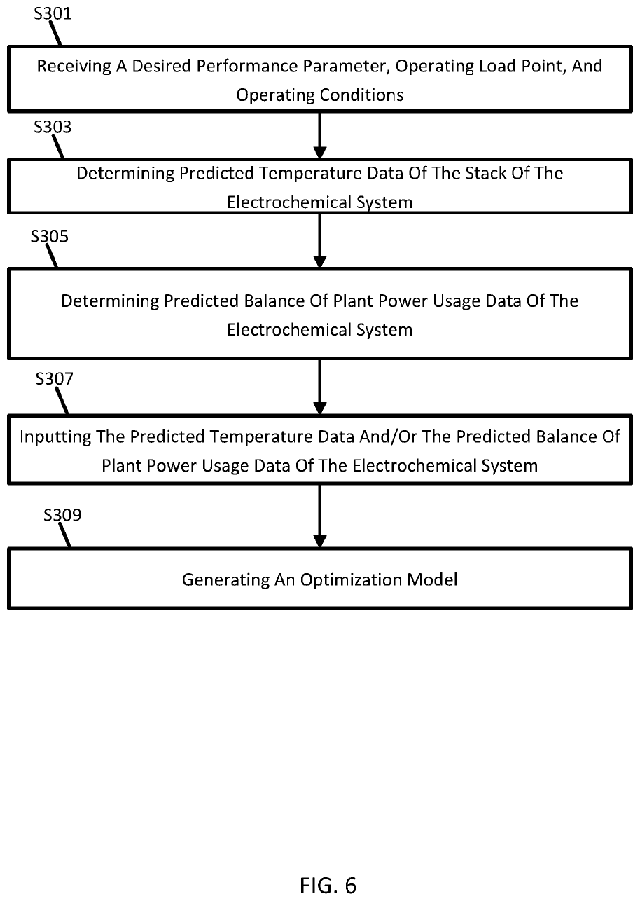

FIG. 6 depicts a flowchart describing a method 300 for generating an optimization model for adjusting an operation of a stack system according to the second embodiment of the present disclosure.

In act S301, the stack optimizer model 260 receives a desired performance parameter of the performance parameters, an operating load point of the operating load points of the stack system 220 of the plant 210, and the operating conditions of the stack system 220 of the plant 210.

In act S303, the cell temperature calculator 266 determines the predicted temperature data of the stack of the electrochemical system 220 based on the collected real-time operating data of the electrochemical system 220. The real-time operating data of the electrochemical system 220 is received from the plant monitoring processor 250.

In act S305, the plant system components parameter calculator 268 determines the predicted balance of plant power usage data of the electrochemical system 220 based on the collected real-time operating data of the electrochemical system. The real-time operating data of the electrochemical system 220 is received from the plant monitoring processor 250.

In act S307, the predicted temperature data and/or the predicted balance of plant power usage data of the electrochemical system are input into the stack optimizer model 260.

In act S309, the stack optimizer model 260 generates the optimization model based on the desired performance parameter, the operating load point of the stack of the electrochemical system, the operating conditions of the stack system 220, the predicted temperature data, and/or the predicted balance of plant power usage data of the electrochemical system.

For example, the objective is to achieve a power output of 150 kW from the plant 210 under specific conditions. In act S301, the stack optimizer model 260 receives inputs including the desired performance parameter, the current operating load point at 70% capacity, and the operating conditions of the plant (25° C. ambient temperature and a hydrogen supply pressure of 45 atm). Act S303 involves the cell temperature calculator 266 predicting the temperature of the fuel cell stack based on real-time data obtained from the plant monitoring processor 250 in act S305. Simultaneously, the plant system components parameter calculator 268 predicts the balance of plant power usage. In act S307, these predictions are input into the stack optimizer model 260. Finally, at act S309, the stack optimizer model 260 generates an optimization model, refining parameters such as hydrogen flow rate or operating temperature to achieve the desired 150 kW power output efficiently. This iterative process ensures the electrochemical system 220 of the plant 210 operates optimally under specific conditions, meeting performance goals set for the power plant 210.

### Electrochemical Optimization Systems-Controlling Hydrogen Flow Rate

FIG. 7 depicts an embodiment of a system 700 for optimizing an operation of an electrochemical system having at least one electrochemical stack 710, at least one power supply unit 720, and an off-taker 702. The system 700 is configured to deliver hydrogen, based on various consumption profiles and customer desired operating points, stably and efficiently at the point of delivery to the customer.

As depicted in FIG. 7, the system 700 includes an off-taker control valve 722 configured to control a flow rate of hydrogen gas at a point of delivery from the electrochemical stack 710 to the off-taker 702. The off-taker 702 may refer to the fluid line leading to the consumer such as into a tank or storage system. The system 700 also includes an electrochemical stack pressure control valve 724 configured to control a pressure of the at least one electrochemical stack (e.g., on a cathode side of the electrochemical stack). The system 700 also includes an off-taker pressure transducer 726 (i.e., PT-1) configured to monitor a pressure of the hydrogen gas line at or near the point of delivery. The system 700 also includes an electrochemical stack pressure transducer 728 (i.e., PT-2) configured to monitor the pressure of at least one electrochemical stack (e.g., on the cathode side of the electrochemical stack 710). The system 700 also includes at least one power supply unit 720 (e.g., at least one rectifier) configured to supply an amount of current to the at least one electrochemical stack 710.

The system 700 also includes at least one processor 770 (i.e., at least one controller) configured to control the operation of the system 700. The processor 770 is configured to receive desired one or more operating set points for the operation of the electrochemical system. This may include a delivery pressure set point for the pressure at the point of delivery and an electrochemical stack pressure set point (e.g., for the cathode side) of the electrochemical stack 710. The desired operating set points may further include a hydrogen production rate set point at the point of delivery. The processor 770 is also configured to receive operating conditions of the electrochemical system including the pressure at the point of delivery and the pressure on the cathode side of the electrochemical stack 710. Additionally, the processor 770 may be configured to determine an adjustment to the off-taker control valve 722, the electrochemical stack pressure control valve 724, the power supply unit 720, or a combination thereof based on an optimization model 760. The optimization model 760, described further below, takes into account the operating conditions of the electrochemical system and the desired operating set points.

The optimization model 760 is configured to optimize the behavior of the electrochemical system. The optimization model considers the operating conditions of the electrochemical system and may include a machine-learned model that is trained using data obtained from the electrochemical system. This data may include real-time and/or historical information on the operation of the electrochemical system. Additionally, or alternatively, the machine-learned model may be trained with data obtained from one or more additional separate electrochemical systems.

In certain examples, the optimization model 760 may be a genetic algorithm, simulated annealing, local minimization, evolutionary algorithm, gradient descent, branch and bound, differential algorithm, hill climbing, or any other algorithm capable of identifying minimums in complex objective functions. Multiple algorithms may be utilized concurrently if deemed necessary. The execution of these algorithms or control functions is managed by the system 700, which governs the overall operation of the electrochemical system.

In certain examples, the system 700 may also include a vent control valve 730 configured to control a flow rate of hydrogen gas being vented via a vent 704 to the atmosphere on the cathode side of the electrochemical stack. The controller 770 may be further configured to determine an adjustment to the vent control valve 730 based on the optimization model 760.

For example, by adjusting the vent control valve 730, the system 700 can regulate the flow rate of hydrogen gas being vented via the vent 704 from the cathode side of the electrochemical stack 710. This adjustment may advantageously help maintain a stable internal pressure within the stack 710, ensuring that the off-taker 702 receives hydrogen at the desired setpoint.

In other words, if the off-taker's demand for hydrogen decreases, the controller 770 may adjust the vent control valve 730 to reduce the flow rate of excess hydrogen being vented, thereby optimizing the overall operation of the system 700 and minimizing wastage. Conversely, if the demand increases, the controller 770 may adjust the vent control valve to ensure sufficient venting capacity while meeting the off-taker's requirements for hydrogen supply.

In certain examples, the system 700 may also include a compressor 732 positioned downstream of the electrochemical stack pressure control valve 724. In certain examples, the compressor 732 may be positioned before the off-taker control valve 722. In an alternative example, the compressor 732 may be positioned after the off-taker control valve 722. The compressor 732 is configured to increase the pressure at the point of hydrogen gas delivery from the electrochemical stack to the off-taker 702. Additionally, the controller 770 is configured to determine an adjustment to the compressor 732 based on the optimization model 760.

For example, by increasing the pressure, the compressor 732 ensures that the hydrogen gas delivered to the off-taker 702 meets the desired pressure levels at the off-taker 702.

Moreover, the controller 770 is configured with the capability to determine adjustments to the compressor 732, leveraging insights derived from the optimization model 760. This allows the system to dynamically adapt the operation of the compressor 732 based on various factors such as real-time demand fluctuations, operational constraints, and optimization objectives.

In other words, if the demand for hydrogen increases and the hydrogen flow rate at the off-taker is increased, the controller 770 may adjust an operational set point of the compressor 732 to increase the pressure accordingly, therein providing adequate supply at the desired pressure set point to meet the heightened demand. Conversely, during periods of reduced demand, the controller 770 may modulate the compressor to maintain optimal pressure levels while minimizing energy consumption and operational costs.

In certain examples, the system 700 may also include a variable area orifice meter 734 configured to change a diameter of an orifice within the hydrogen gas transfer line to the off-taker 702. This orifice adjustment may assist in adjusting the pressure of the hydrogen gas at or near the point of hydrogen gas delivery from the electrochemical stack 710 to the off-taker 702. The controller 770 is further configured to determine an adjustment to the variable area orifice meter 734 based on the optimization model 760.

For example, by altering the diameter of the orifice, the meter 734 can modulate the flow rate and adjust the pressure levels to meet the specific requirements desired at the point of delivery to the off-taker 702.

In other words, if the point of delivery to the off-taker 702 requires a higher pressure for a certain period, the controller 770 may instruct the variable area orifice meter 734 to reduce the orifice diameter, thereby increasing the pressure at the delivery point. Conversely, if lower pressure levels are needed, the controller 770 may adjust the orifice diameter accordingly to achieve the desired pressure and/or flow rate.

As depicted in FIG. 7, the electrochemical optimization system 700, in addition to the processor 770, also includes two proportional-integral controllers 772 (i.e., PIC-1, PIC-2), at least one memory 774, a communication interface 776 (e.g., a graphical user interface), a data acquisition unit 778, and an optimization model 760, which are described further below with respect to FIG. 18.

The optimization model 760 may be implemented using the processor 770, the two PICs 772, and/or the memory 774. The system 700 may be incorporated as one system with one or more processors within the system 700. In another embodiment, however, the system 700 may incorporate separate and distinct sub-systems having separate processors.

The memory 774 may store one or more sets of rules, algorithms, or optimization models generated by the optimization model 760 for controlling the electrochemical system. The processor 770 may implement or execute the one or more sets of rules, algorithms, or optimization models via the two PICs 772. In other words, the processor 770 may transmit the one or more set of rules, algorithms, or optimization models to the two PICs 772 such that the PICs 772 may adjust one or more setpoints for the operation of the system 700 based on the optimization model 760.

In this depicted example, for the operation of the electrochemical system, the PICs 772 are configured to control the electrochemical system by adjusting the off-taker control valve 722, the electrochemical stack pressure control valve 724, the power supply unit 720, the vent control valve 730, the compressor 732, the variable area orifice meter 734, or a combination thereof, based on the optimization model 760.

The data acquisition unit 778 is configured to monitor the performance of the system 700. As mentioned above, the system 700 includes components such as the compressor 732 to facilitate the movement of fluids within the system 700, valves 722, 724, and 730 configured to control the flow of fluids, a power supply unit 720 configured to provide current to the electrochemical stack 710, a variable area orifice meter 734, and sensors 726 and 728 configured to provide real-time data to enable precise system control. The data acquisition unit 778 is configured to systematically capture the operating conditions of the system 700 including the operating conditions of the components.

The operating conditions of the system 700 may include real-time operating data and ambient operating conditions of the system 700. The real-time operating data may include the current applied to the electrochemical stack 710 via the power supply unit 720. Additionally, the real-time operating data may include the fluid flow rates, temperature levels, pressure conditions, and sensor feedback of the system 700. These parameters serve as critical indicators of the state of the electrochemical system.

Additionally, real-time data refers to the capability of a system to respond or provide results instantly or with minimal delay. In other words, data is processed, or events are handled as they occur, without significant delay.

In this depicted example, the data acquisition unit 778 monitors the performance and health of the electrochemical system. For example, the data acquisition unit 778 is configured to monitor the performance of the stack 710 within the electrochemical system and the components of the electrochemical system. The data acquisition unit 778 systematically captures the crucial operating parameters of the stack of the electrochemical system such as the fluid flow rates, temperature levels, and pressure conditions at the anode and cathode inlets and outlets of the stack. The received parameters may be transmitted by the data acquisition unit 778 to be stored in the memory 774 as data records, transmitted to the stack optimizer model 760 for training and analysis, and/or transmitted to the processors 770 and 772 to control or adjust the parameters of the system 700.

Referring back to FIG. 7, two loops (i.e., a primary control loop and an internal pressure control loop) are depicted in dashed lines. The two loops directly influence hydrogen delivery to the customer. Each control loop has a corresponding PIC 772 of the two PICs 772. The primary control loop is controlled by corresponding PIC-1 and the internal pressure control loop is controlled by PIC-2. PIC-1 may be tasked with maintaining constant pressure at the point of delivery. It achieves this by adjusting the “hydrogen production setpoint” or the “Electrolyzer Current Setpoint” in response to changes in the “Pressure at the Point of Delivery,” as measured by the pressure transducer (PT-1) 726.

In other words, variations in downstream hydrogen flow (consumption changes) directly impact the pressure reading at the point of delivery. Consequently, when consumption increases, pressure drops, prompting PIC-1 to elevate the hydrogen setpoint to match the desired consumption, ensuring hydrogen production mirrors consumption trends. Conversely, when consumption decreases, pressure at the point of delivery rises, prompting PIC-1 to lower the production setpoint, thus aligning production with consumption levels.

Controlling the power supply unit 720 to adjust the current supplied to the electrochemical stack 710 may be directly proportional to the hydrogen set point. In other words, an increased hydrogen setpoint may prompt the power supply unit 720 to increase the current supplied to the electrochemical stack 710, thereby enhancing hydrogen production. Conversely, a decreased hydrogen setpoint may lead to a reduction in the current supplied to the electrochemical stack 710, consequently lowering hydrogen output. This direct proportionality ensures that the electrochemical stack 710 operation remains closely aligned with the desired hydrogen production levels, enabling efficient and responsive control over the electrochemical system's performance.

The internal pressure control loop is responsible for maintaining the internal pressure of the electrochemical stack 710 (e.g., on the cathode side) at a designated setpoint. This may be achieved by measuring internal pressure by the pressure transducer (PT-2) 728, comparing it to the hydrogen setpoint, and adjusting the electrochemical stack pressure control valve 724 to maintain PT-2 at the desired level. The interaction between these two control loops is advantageous for optimizing the overall performance of hydrogen delivery.

The optimization model 760 optimizes the behavior of the electrochemical system by assuming a (direct) proportional relationship between the current applied to the electrochemical stack 710 and the amount of hydrogen produced. The optimization model 760 simulates the electrochemical system's behavior by adjusting the hydrogen flow rate in response to changes in control signals at the hydrogen delivery point. This simplification allows for a straightforward representation of the electrochemical system's functionality within the overall model, facilitating analysis and optimization of hydrogen production and delivery.

For example, in the operational setup described above, PIC-1 functions to uphold a consistent pressure at the point of delivery to the Off-Taker 702, with the specified setpoint set of, for example, 32 Barg (or 32 atmg), adjustable as needed by the Off-Taker or Customer. Its output, representing the hydrogen flow setpoint, directly influences the rate of hydrogen production by the system 700, ensuring adherence to the designated delivery pressure.

Simultaneously, PIC-2 is dedicated to maintaining a steady pressure within the Cathode side of the system 700, with a predetermined setpoint of, for example, 34 Barg (or 34 atmg). To ensure proper sequencing of operations and prevent untimely adjustments, a condition is imposed on PIC-1's functionality: the hydrogen flow setpoint it generates will not impact the cell stack current until the internal pressure of the system reaches 30 Barg (or 30 atmg). Though this threshold is arbitrarily chosen, it serves a crucial role in preventing operational instability or inefficiencies within the system, contributing to its reliable and optimized performance.

### Off-Taker Configurations

The systems provided may advantageously accommodate multiple situations based on customer-desired operating set points, which are described below.

Three different cases are provided, as non-limiting examples, where the system 700 optimizes a specific operation of the electrochemical system. FIGS. 8-18 depict results provided from these three different cases for optimizing an operation of an electrochemical system having an electrochemical stack.

The first case involves low-pressure consumption downstream, where hydrogen is stored in a tank, and variable demand.

The second case involves high-pressure consumption downstream, where hydrogen is stored in a tank, and variable demand. In addition, regulatory control is implemented to ensure the outlet pressure remains consistent.

The third case involves high-pressure consumption downstream, where hydrogen is stored in a tank, and variable demand. However, in this case, on/off control mechanisms are employed to regulate the outlet pressure in response to variable demand.

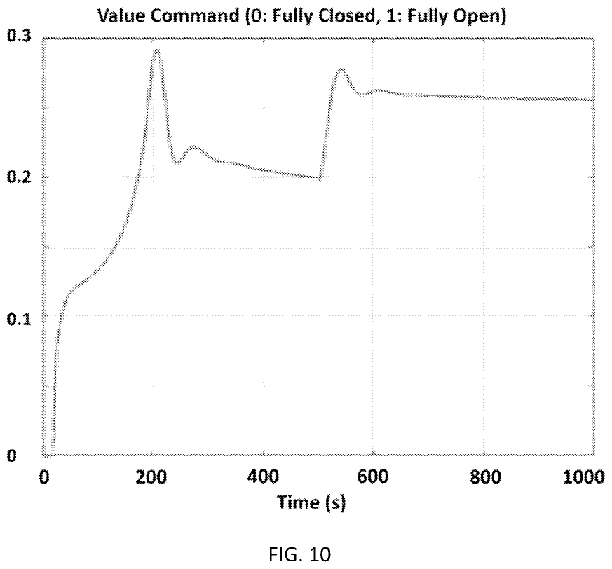

In the first case, downstream consumption operates at low-pressure levels, with the Off-Taker 702 storing hydrogen in a tank to subsequently supply downstream demand. The variability in consumption is accounted for by assuming fluctuating demand levels. In this case, a variable area orifice is introduced into the downstream line. The results from the first case are depicted in FIGS. 8-10. FIG. 8 depicts the results of the pressure at point of delivery and at internal pressure of the electrochemical stack. FIG. 9 depicts the results of the PIC-1's output (Hydrogen Flow Setpoint) in response to a change in demand of hydrogen. FIG. 10 depicts the results of the PIC-2's output (valve 724) in response to a change in demand of hydrogen.

For example, in the first case, the electrochemical system 700 initiates from a full shutdown state, implying the absence of initial gas in the system 700. Subsequently, following the start command, the hydrogen flow setpoint surges to its maximum value, while the valve 724 remains closed to facilitate the buildup of internal pressure in the electrochemical stack 710. As the internal pressure approaches, for example, 30 barg (31 bara), the PIC-1 becomes active to maintain the pressure at the point of delivery. Initially, with the customer hydrogen tank empty, the PIC-1 output remains at its highest value, maximizing the capacity of the electrolyzer. As depicted in FIGS. 8 and 9, at around time t=200, the pressure at the point of delivery reaches its setpoint of 32 barg, prompting PIC-1 to gradually lower the hydrogen setpoint to sustain pressure by balancing hydrogen production and consumption. In other words, the power supply unit 720 lowers the current applied to the electrochemical stack 710 as the valve 722 is actuated. This adjustment in hydrogen flow causes deviations in internal pressure, which are then compensated by PIC-2 through adjustments to the valve 724.

To demonstrate the Off-taker following control scheme's response to changes in hydrogen demand, a step change is introduced into the customer demand. This change is simulated by abruptly altering the orifice diameter of a variable orifice restriction meter 734 at time t=500, increasing the demand. As shown in FIG. 8, this induces an initial pressure drop at the point of delivery, swiftly compensated by PIC-1. PIC-1 responds by increasing the hydrogen setpoint to counteract the pressure drop, as illustrated in FIG. 9. The increase in hydrogen flow momentarily raises the internal pressure, subsequently balanced by PIC-2 through adjustments to the valve 724, as depicted in FIG. 10.

In cases 2 and 3, industrial hydrogen storage and consumption demand higher pressure levels. Thus, it is advantageous to model the process of delivering or transporting hydrogen at these elevated pressures. In this context, it is assumed that the Off-taker utilizes a compressor to boost the hydrogen pressure, storing the compressed hydrogen in a tank before supplying it downstream for consumption. The downstream consumption is presumed to exhibit variability over time. These cases allow for the examination of different control strategies employed by the Off-taker under varying operational requirements and constraints.

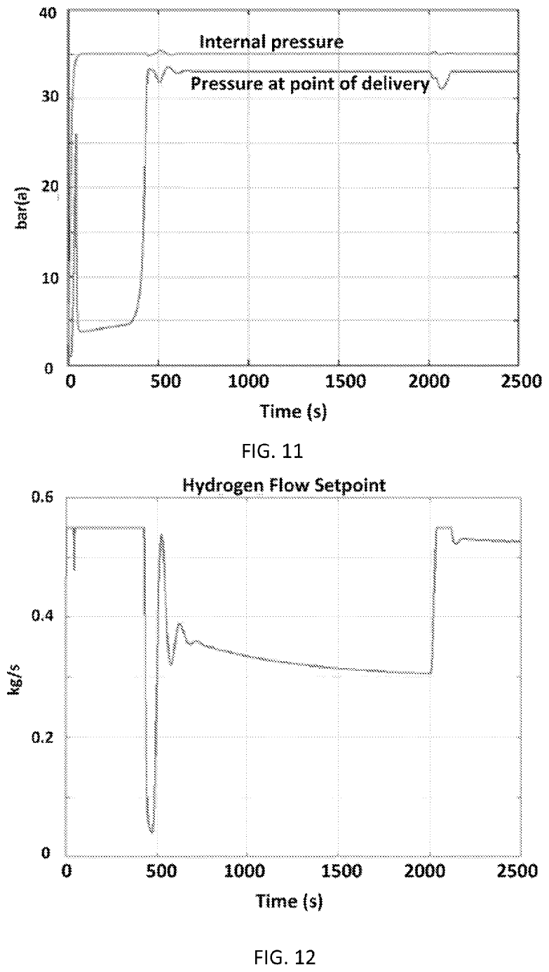

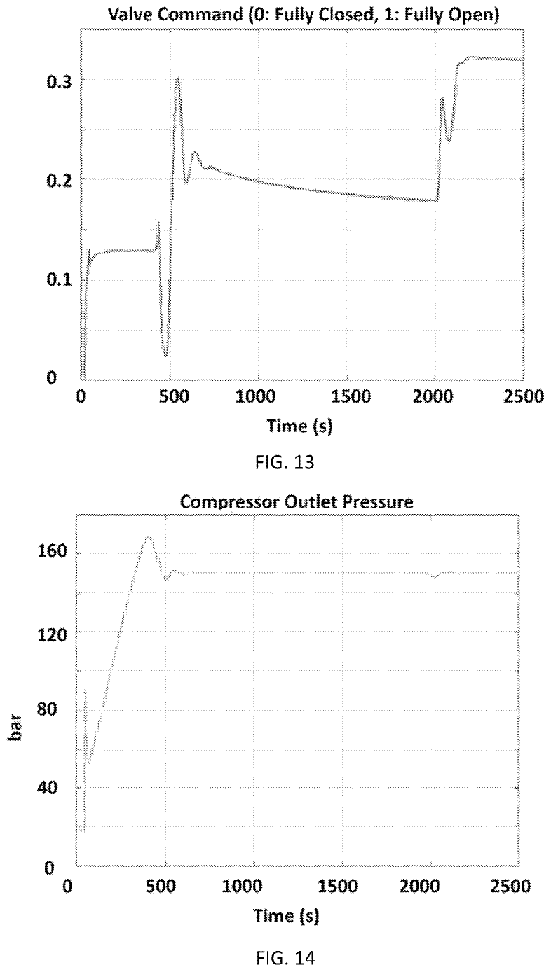

Case 2 reflects a scenario where the downstream process of the Off-taker is sensitive to pressure changes, necessitating tight regulatory control over the pressure levels. FIGS. 11-14 depict the results for optimizing an operation of an electrochemical system having an electrochemical stack for case 2. FIG. 11 depicts the results of the pressure at point of delivery and at the internal pressure of the electrochemical stack for case 2. FIG. 12 depicts the results of the PIC-1's output (Hydrogen Flow Setpoint) in response to a change in demand of hydrogen for case 2. FIG. 13 depicts the results of the PIC-2's output (valve 724)) in response to a change in demand of hydrogen for case 2. FIG. 14 depicts the results of the pressure at the outlet of the compressor for case 2.

Referring to case 2, to maintain the compressor output pressure consistently at, for example, 150 barg, the processor 770 is implemented. The processor 770 controls PT-1 726 to measure the pressure, and the processor 770 compares the measured pressure with the setpoint, and then adjusts the compressor's 732 speed accordingly. Additionally, it is assumed that the compressor 732 remains inactive until certain conditions are met: specifically, the internal pressure of the electrochemical stack 710 reaching its setpoint, the valve 724 beginning to open, and the pressure at the point of delivery exceeding a predefined threshold. To model this behavior, the “Pressure at the point of delivery” is introduced to a “Relay” block (not illustrated). The parameters of the relay block are configured such that when the pressure surpasses 27 bar, the relay output transitions from 0 to 1, enabling the controller 770 output to take effect and initiate the compressor 732.

For the demonstration of variable demand, the opening of the variable orifice is adjusted from 10 percent to 80 percent at time t=2000s. The results are depicted in FIGS. 11-14. As with previous simulations, the electrochemical system begins from a full shutdown state, meaning there is no initial gas in the system. Upon receiving the start command at time t=0, the hydrogen flow setpoint immediately increases to its maximum value, while the valve 724 remains closed to allow for the buildup of internal pressure in the electrolyzer. Once the internal pressure reaches 30 barg (31 bara), PIC-1 initiates pressure maintenance at the point of delivery. Simultaneously, the Off-taker compressor 732 begins operation, drawing hydrogen from the output stage of the electrolyzer. Initially, this causes a drop in pressure at the point of delivery, which gradually recovers and approaches its setpoint of 32 barg (33 bara) around t=400s, as depicted in FIG. 11. This coincides with the filling of the Off-taker high-pressure storage tank (not illustrated), which approaches its setpoint of 150 barg, as shown in FIG. 14. During the initial tank fill-up phase, indicated by the hydrogen setpoint remaining at its maximum level in FIG. 12, PIC-1 subsequently adjusts the hydrogen setpoint to match consumption at the Off-taker side (i.e., increasing the current supplied to the electrochemical stack 710). When the Off-taker consumption changes at t=2000s, as illustrated in FIGS. 11 and 12, the pressure at the point of delivery drops, prompting PIC-1 to increase hydrogen production to compensate. Simultaneously, PIC-2 adjusts the valve 724 opening to maintain the internal pressure at the setpoint of 34 barg (35 bara), as depicted in FIG. 13. Finally, FIG. 14 displays the pressure at the outlet of the compressor 732, which is regulated to remain constant at 150 bar.

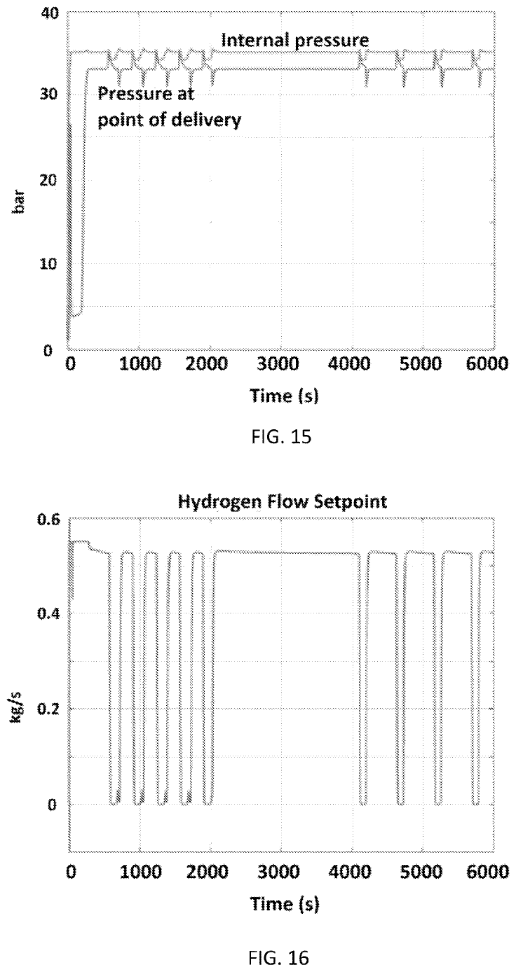

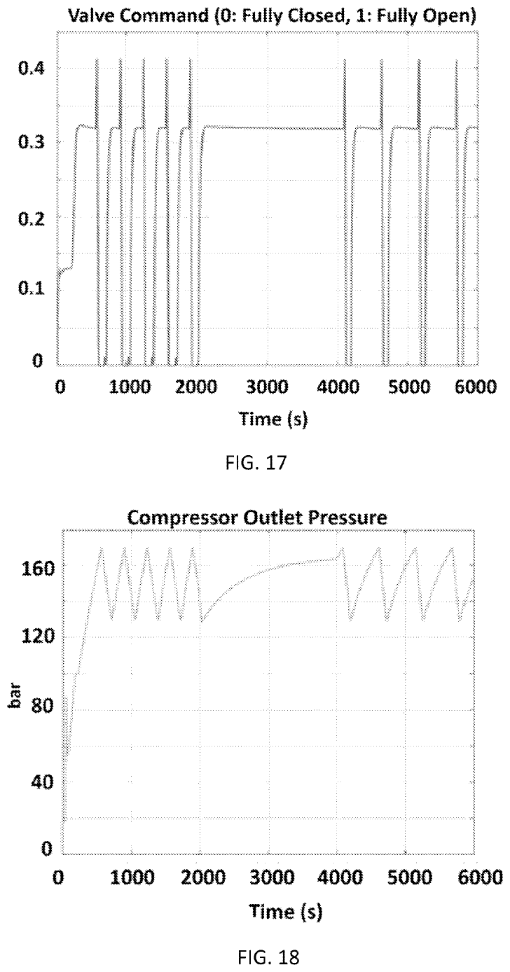

Conversely, Case 3 represents a condition where the downstream process of the Off-taker can function within a range of pressure levels, making an On/Off control algorithm sufficient to maintain the pressure within an acceptable band. FIGS. 15-18 depict the results for optimizing an operation of an electrochemical system having an electrochemical stack for case 3. FIG. 15 depicts the results of the pressure at point of delivery and at the internal pressure of the electrochemical stack for case 3. FIG. 16 depicts the results of the PIC-1's output (Hydrogen Flow Setpoint) in response to a change in demand of hydrogen for case 3. FIG. 17 depicts the results of the PIC-2's output (valve 724) in response to a change in demand of hydrogen for case 3. FIG. 18 depicts the results of the pressure at the outlet of the compressor for case 3.

In Case 3, the objective is to maintain the compressor 732 outlet pressure within a specified range, rather than regulating it to a fixed value as in Case 2. To achieve this, a different control strategy is employed where the compressor 732 operates in an on/off manner based on the outlet pressure hitting predetermined high or low thresholds. This control scheme is represented by a relay block (not illustrated).

The relay output switches to 1 when the input pressure at the outlet of the compressor 732 drops below 130 barg, indicating the need to activate the compressor 732. Conversely, the relay output switches to 0 when the input pressure rises above 170 barg, signifying that the compressor 732 should be deactivated. This setup implies that the Off-taker downstream process is capable of operating within a pressure range of 150 barg+20.

For demonstration purposes, changes in consumption are simulated twice. Firstly, the variable orifice 734 opens from 10 percent to 80 percent at time t=2000s, indicating an increase in demand. Secondly, the variable orifice 734 then closes from 80 percent to 30 percent at time t=4000s, representing a decrease in demand. These changes in consumption allow for the observation of how the system responds to fluctuations in demand under the specified control strategy.

The results of the simulation are illustrated in FIGS. 15-18. Initially, the response mirrors that of the previous case, with similar trends observed. However, a notable difference arises when the pressure at the outlet of the compressor 732 reaches 170 barg around t=600s, as depicted in FIG. 18. At this point, the compressor 732 ceases operation, leading to a spike in the pressure at the point of delivery, as shown in FIG. 15.

In response to this spike, PIC-1 reacts by reducing hydrogen production to “0,” as evidenced in FIG. 16. While the compressor 732 remains inactive, hydrogen is consumed downstream, gradually lowering the pressure in the Off-taker storage tank until it reaches 13 barg. Subsequently, the compressor 732 restarts, causing a dip in the pressure at the point of delivery, prompting PIC-1 to maximize hydrogen production, as illustrated in FIGS. 15 and 16. This cycle continues, with the pressure in the Off-taker storage tank increasing until it reaches 17 barg, repeating the cycle.

Referring to FIGS. 15-18, at t=2000s, the increase in consumption results in a balance between production and consumption at around 160 barg at the compressor 732 outlet, ensuring the compressor remains on without further cycling. However, when consumption is reduced at t=4000s, the cycling resumes, albeit at a different duty cycle due to the variation in consumption (variable orifice at 30 percent compared to the initial 10 percent). Simultaneously, PIC-2 772 maintains control over internal pressure, regulating it to the setpoint of 34 barg, as depicted in FIG. 17.

### Methods Of Operation

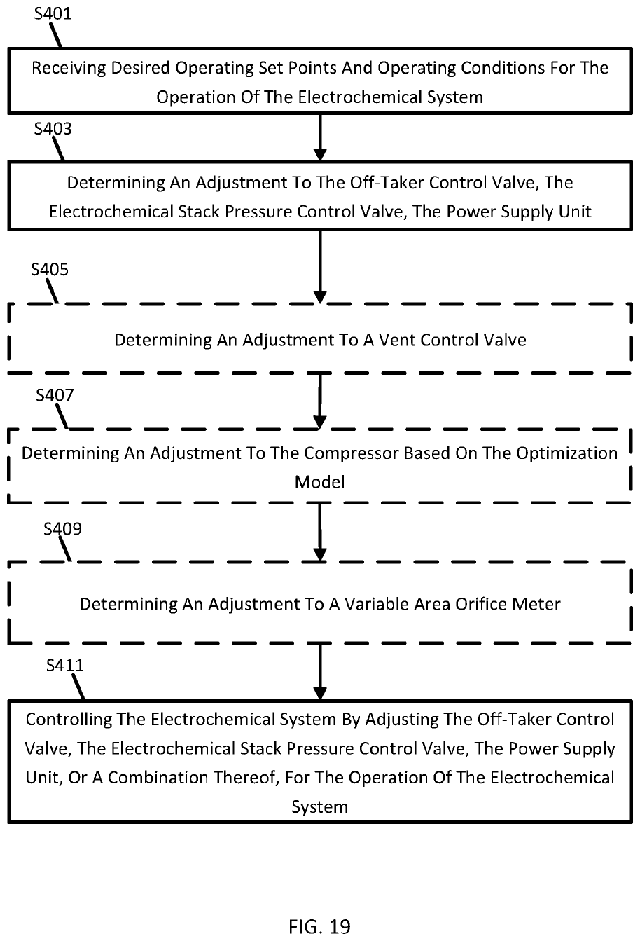

FIG. 19 depicts a flowchart describing a method for optimizing an operation of an electrochemical system having an electrochemical stack. In act S401, the controller receives desired operating set points, which include the delivery pressure set point and the electrochemical stack pressure set point. It also receives current operating conditions, such as the pressure at the delivery point and the pressure on the cathode side of the electrochemical stack.

In act S403, based on an optimization model, the controller adjusts various components of the system. These adjustments can include altering the off-taker control valve, the electrochemical stack pressure control valve, the power supply unit, or a combination thereof. As mentioned above, the optimization model may be iteratively repeated and the off-taker control valve, the electrochemical stack pressure control valve, the power supply unit, or a combination thereof may be iteratively adjusted based on updates to the operating conditions of the electrochemical system. In certain examples, the optimization model may be determined using a learned model.

In act S405, based on the optimization model, the controller may optionally determine an adjustment to a vent control valve. The vent control valve may be configured to control a flow rate of hydrogen gas being vented to the atmosphere on the cathode side of the electrochemical stack.

In act S407, based on the optimization model, the controller may optionally determine an adjustment to the compressor based on the optimization model. The compressor may be positioned between the electrochemical stack pressure control valve and the off-taker control valve. The compressor may also be configured to increase the pressure at the point of hydrogen gas delivery from the electrochemical stack to the off-taker.

In act S409, based on the optimization model, the controller may optionally determine an adjustment to a variable area orifice meter. The variable area orifice meter may be configured to change a diameter of an orifice such as to provide a change in the pressure at the point of hydrogen gas delivery from the electrochemical stack to the off-taker.

In act S411, based on the optimization model, the controller may control the electrochemical system by adjusting the off-taker control valve, the electrochemical stack pressure control valve, the power supply unit, or a combination thereof, for the operation of the electrochemical system.

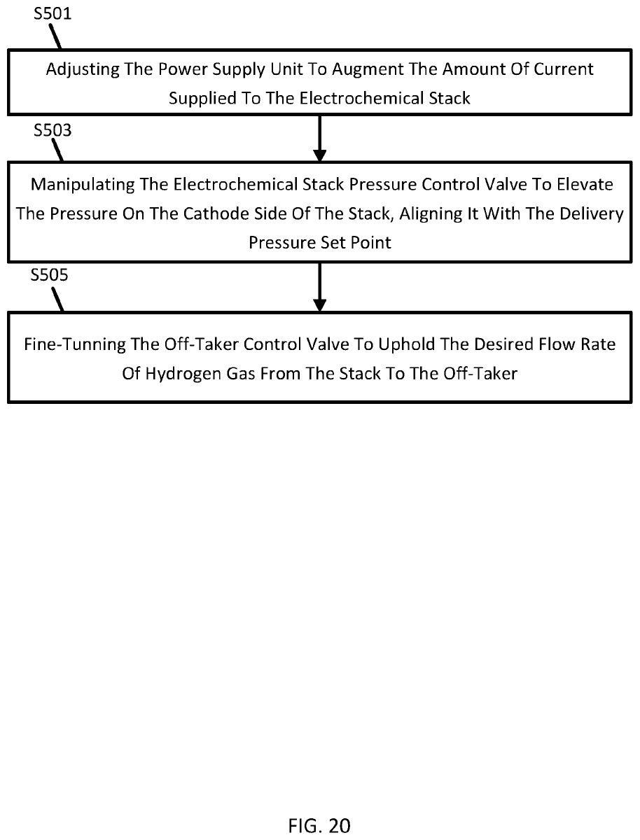

FIG. 20 depicts a flowchart describing a method for optimizing an operation of an electrochemical system having an electrochemical stack when an amount of hydrogen consumption increases at a point of delivery to the off-taker.

In response to an increase in hydrogen consumption at the delivery point, the optimization model may determine and provide instructions to make one or more adjustments to ensure optimal performance to the controller. In act S501, the power supply unit adjusts (e.g., increases) the amount of current supplied to the electrochemical stack. This increase in current may increase in the amount of hydrogen gas production within the stack.

In act S503, the electrochemical stack pressure control valve may be adjusted to control (e.g., increase) the pressure on the cathode side of the stack, aligning it with the delivery pressure set point. This adjustment provides consistent pressure levels for efficient gas delivery.

In act S505, the off-taker control valve may be adjusted to uphold the desired flow rate of hydrogen gas from the stack to the off-taker.

In this example, the one or more adjustments to the power supply unit, the electrochemical stack pressure control valve, and/or the off-taker control valve may be made (e.g., at a same time) to optimize the delivery of hydrogen gas precisely at the point of transfer from the electrochemical stack to the off-taker, thereby maintaining system stability and efficiency.

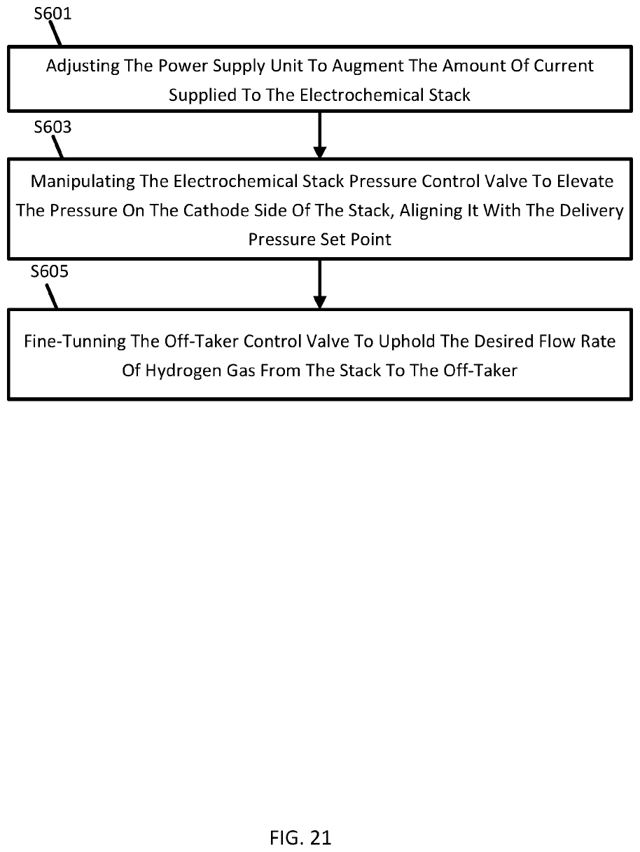

FIG. 21 depicts a flowchart describing a method for optimizing an operation of an electrochemical system having an electrochemical stack when an amount of hydrogen consumption decreases at a point of delivery to the off-taker.

In response to a decrease in hydrogen consumption at the delivery point, the optimization model dictates a series of adjustments to ensure optimal performance to the controller. In act S601, the power supply unit adjusts (e.g., decreases) the amount of current supplied to the electrochemical stack. The decrease in current may lower the amount of hydrogen gas production within the stack.

In act S603, the electrochemical stack pressure control valve may be adjusted to control (e.g., increase) the pressure on the cathode side of the stack, aligning it with the delivery pressure set point. This adjustment ensures consistent pressure levels for efficient gas delivery.

In act S605, the off-taker control valve may be adjusted to uphold the desired flow rate of hydrogen gas from the stack to the off-taker.

In this method, the one or more adjustments to the power supply unit, the electrochemical stack pressure control valve, and/or the off-taker control valve may be made (e.g., at a same time) to optimize the delivery of hydrogen gas precisely at the point of transfer from the electrochemical stack to the off-taker, thereby maintaining system stability and efficiency.

### System for Controlling Operation of the Electrochemical Operation Systems

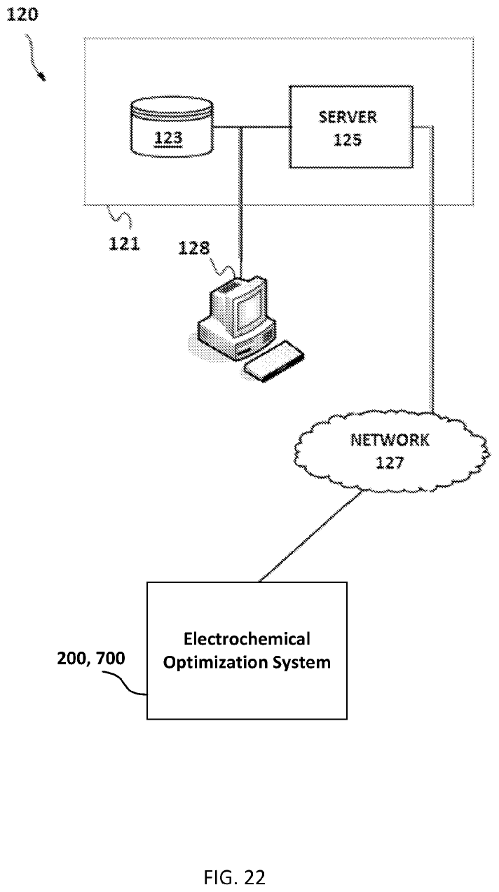

FIG. 22 illustrates an exemplary system 120 for controlling operation of the electrochemical optimization system 200, 700. The depicted operating system 120 includes the electrochemical optimization system 200, 700 as described above, as well as a monitoring system (e.g., including a data acquisition unit) 121, a workstation 128, and a network 127.

The monitoring system 121 includes a server 125 and a database 123. The monitoring system 121 may include computer systems and networks of a system operator (e.g., the operator of the system 200, 700). The server database 123 may be configured to store information regarding the operating conditions or setpoints for optimizing the performance of the system 200, 700.

The monitoring system 121, the workstation 128, and the electrochemical optimization system 200, 700 are coupled with the network 127. The phrase “coupled with” is defined to mean directly connected to or indirectly connected through one or more intermediate components. Such intermediate components may include hardware and/or software-based components. As such, any data collection via control valves, flow meters, pressure regulators, or sensors within the electrochemical optimization system 200, 700 may be optionally transmitted via the connected network to the monitoring system 121, or workstation 128 for analysis.

The optional workstation 128 may be a general-purpose computer including programming specialized for providing input to the server 125. For example, the workstation 128 may provide settings for the server 125. The workstation 128 may include at least a memory, a processor, and a communication interface.

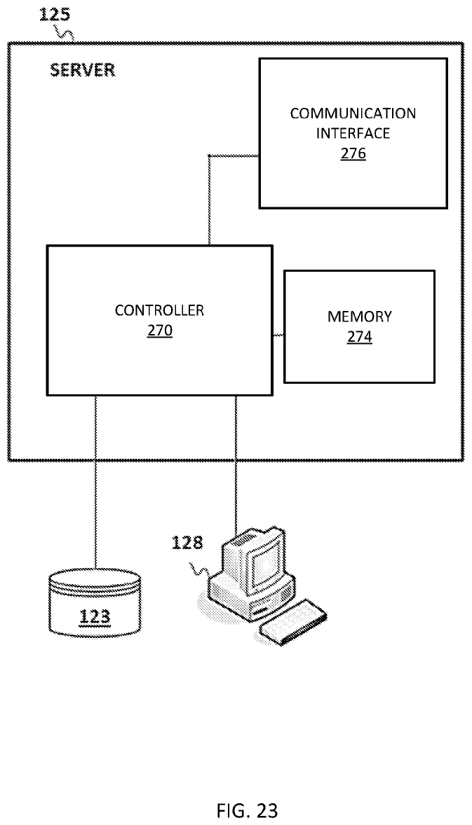

FIG. 23 illustrates an exemplary server 125 of the system 200, 700 of FIGS. 2, 3, and 7. The server 125 includes a memory 274, a controller or processor 270, and a communication interface 276. The server 125 may be coupled to a database 123 and a workstation 128. The workstation 128 may be used as an input device for the server 125. The communication interface 276 receives data indicative of use inputs made via the workstation 128 or a separate electronic device.

The controllers or processors 240, 250, and 270 may include a general processor, digital signal processor, an application specific integrated circuit (ASIC), field programmable gate array (FPGA), analog circuit, digital circuit, combinations thereof, or other now known or later developed processors. The controllers or processors 240, 250, and 270 may be a single device or a combination of devices, such as associated with a network, distributed processing, or cloud computing.

The controllers or processors of the system 200, 700 may also be configured to optimize an operation of an electrochemical plant containing at least one electrochemical system. For example, the processor 240 may be configured to control the plant 210 based on parameters defined in an optimization model generated by a stack optimizer model 260. The processor 250 (i.e., a data acquisition unit) may be configured to monitor the plant performance and the health of the plant. The processor 250 may be configured to measure, monitor, and/or receive data. The processor 270 may be configured to transmit the one or more set of rules, algorithms, or optimization models to the processor 240 such that the processor 240 adjusts one or more setpoints for the operation of the electrochemical system 220 based on the optimization model.

The memory 274 may be a volatile memory or a non-volatile memory. The memory 274 may include one or more of a read-only memory (ROM), random access memory (RAM), a flash memory, an electronic erasable program read-only memory (EEPROM), or other type of memory. The memory 274 may be removable from the device 122, such as a secure digital (SD) memory card.

The communication interface 276 may include any operable connection. An operable connection may be one in which signals, physical communications, and/or logical communications may be sent and/or received. An operable connection may include a physical interface, an electrical interface, and/or a data interface. The communication interface 276 provides for wireless and/or wired communications in any now known or later developed format.

The communication interface 276 may also include a graphical user interface (GUI). The GUI instructions are stored in the memory 274 and executable by the processor 270. The GUI may be used for one or more purposes, including to convey and/or receive information about the users, displaying (e.g., outputting) data, displaying notifications, and the like.

In the above-described examples, the network 127 may include wired networks, wireless networks, or combinations thereof. The wireless network may be a cellular telephone network, an 802.11, 802.16, 802.20, or WiMax network. Further, the network 127 may be a public network, such as the Internet, a private network, such as an intranet, or combinations thereof, and may utilize a variety of networking protocols now available or later developed including, but not limited to TCP/IP based networking protocols.

While the non-transitory computer-readable medium is described to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting example, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative example, dedicated hardware implementations, such as application specific integrated circuits, programmable logic arrays and other hardware devices, may be constructed to implement one or more of the methods described herein. Applications that may include the apparatus and systems of various examples may broadly include a variety of electronic and computer systems. One or more examples described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations may include distributed processing, component/object distributed processing, and parallel processing. Alternatively, virtual computer system processing may be constructed to implement one or more of the methods or functionalities as described herein.

Although the present specification describes components and functions that may be implemented in particular embodiments with reference to particular standards and protocols, the claim scope is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having the same functions. Accordingly, replacement standards and protocols having the same or similar functions as those disclosed herein are considered equivalents thereof.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

As used in this application, the term “circuitry” or “circuit” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any digital computer. A processor may receive instructions and data from a read only memory or a random-access memory or both. Components of a computer include a processor for performing instructions and one or more memory devices for storing instructions and data. The computer may also include or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media, and memory devices, including by way of example semiconductor memory devices, e.g., E PROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments of the subject matter described in this specification may be implemented on a device having a display, e.g., a CRT (cathode ray tube), LCD (liquid crystal display), or LED (light emitting diode) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments of the subject matter described in this specification may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the subject matter described in this specification, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server may be remote from each other and may interact through a communication network. The relationship of client and server arises by virtue of computer programs running on the respective computers and having a client-server relationship with each other.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

1.-21. (canceled)

22. A method for optimizing an operation of an electrochemical system having an electrochemical stack, the method comprising:
receiving desired operating set points for the operation of the electrochemical system comprising a delivery pressure set point at a point of delivery and an electrochemical stack pressure set point for a cathode side of the electrochemical stack;
receiving operating conditions of the electrochemical system comprising a pressure at the point of delivery and a pressure on the cathode side of the electrochemical stack; and
determining an adjustment to an off-taker control valve, an electrochemical stack pressure control valve, a power supply unit, or a combination thereof based on an optimization model,
wherein the off-taker control valve controls a flow rate of hydrogen gas at the point of delivery from the electrochemical stack to an off-taker,
wherein the electrochemical stack pressure control valve controls the pressure on the cathode side of the electrochemical stack,
wherein an off-taker pressure transducer monitors the pressure at the point of delivery,
wherein an electrochemical stack pressure transducer monitors the pressure on the cathode side of the electrochemical stack,
wherein the power supply unit supplies an amount of current to the electrochemical stack, and
wherein the optimization model takes into account the operating conditions of the electrochemical system.

23. The method of claim 22, further comprising:
determining an adjustment to a vent control valve based on the optimization model,
wherein the vent control valve controls a flow rate of hydrogen gas being vented to atmosphere on the cathode side of the electrochemical stack.

24. The method of claim 22, further comprising:
determining an adjustment to a compressor based on the optimization model,
wherein the compressor adjusts the pressure at the point of hydrogen gas delivery from the electrochemical stack to the off-taker, and
wherein the compressor is positioned downstream of the electrochemical stack pressure control valve.

25. The method of claim 22, further comprising:
determining an adjustment to a variable area orifice meter based on the optimization model,
wherein the variable area orifice meter changes a diameter of an orifice such as to provide a change in the pressure at the point of hydrogen gas delivery from the electrochemical stack to the off-taker.

26. The method of claim 22, wherein the optimization model is iteratively repeated and the off-taker control valve, the electrochemical stack pressure control valve, the power supply unit, or a combination thereof are iteratively adjusted based on updates to the operating conditions of the electrochemical system.

27. The method of claim 22, wherein the optimization model is determined using a learned model.

28. The method of claim 22, wherein the operating conditions of the electrochemical system further comprise real-time operating data of the electrochemical system including power supply module data, electrochemical stack data, and balance of power usage data.

29. The method of claim 22, wherein the desired operating set points further comprise a hydrogen production rate at the point of delivery.

30. The method of claim 22, further comprising:
controlling the electrochemical system by adjusting the off-taker control valve, the electrochemical stack pressure control valve, the power supply unit, or a combination thereof, for the operation of the electrochemical system based on the optimization model.

31. The method of claim 22, wherein, based on the optimization model, when an amount of hydrogen consumption increases at the point of delivery, the method further comprises:
adjusting the power supply unit to increase the amount of current supplied to the electrochemical stack;
adjusting the electrochemical stack pressure control valve to increase pressure on the cathode side of the electrochemical stack to reach the delivery pressure set point; and
adjusting the off-taker control valve to maintain the flow rate of hydrogen gas, at the point of delivery from the electrochemical stack to the off-taker, with the desired operating set points,
wherein the adjusting of the power supply unit, the electrochemical stack pressure control valve, and the off-taker control valve optimize delivery of hydrogen gas at the point of hydrogen gas delivery from the electrochemical stack to the off-taker.

32. (canceled)

33. The method of claim 22, wherein, based on the optimization model, when an amount of hydrogen consumption decreases at the point of delivery, the method further comprises:
adjusting the power supply unit to decrease the amount of current supplied to the electrochemical stack;
adjusting the electrochemical stack pressure control valve to increase pressure on the cathode side of the electrochemical stack to reach the delivery pressure set point; and
adjusting the off-taker control valve to maintain the flow rate of hydrogen gas, at the point of delivery from the electrochemical stack to the off-taker, with the desired operating set points,
wherein the adjusting of the power supply unit, the electrochemical stack pressure control valve, and the off-taker control valve optimize delivery of hydrogen gas at the point of hydrogen gas delivery from the electrochemical stack to the off-taker.

34. (canceled)

35. A system for optimizing an operation of an electrochemical system having an electrochemical stack, the system comprising:
an off-taker control valve configured to control a flow rate of hydrogen gas at a point of delivery from the electrochemical stack to an off-taker;
an electrochemical stack pressure control valve configured to control a pressure on a cathode side of the electrochemical stack;
an off-taker pressure transducer configured to monitor a pressure at the point of delivery;
an electrochemical stack pressure transducer configured to monitor the pressure on the cathode side of the electrochemical stack;
a power supply unit configured to supply an amount of current to the electrochemical stack; and
a controller configured to:
receive desired operating set points for the operation of the electrochemical system comprising a delivery pressure set point for the pressure at the point of delivery and an electrochemical stack pressure set point for the cathode side of the electrochemical stack;
receive operating conditions of the electrochemical system comprising the pressure at the point of delivery and the pressure on the cathode side of the electrochemical stack; and
determine an adjustment to the off-taker control valve, the electrochemical stack pressure control valve, the power supply unit, or a combination thereof based on an optimization model,
wherein the optimization model takes into account the operating conditions of the electrochemical system.

36. The system of claim 35, further comprising:
a vent control valve configured to control a flow rate of hydrogen gas being vented to atmosphere on the cathode side of the electrochemical stack,
wherein the controller is further configured to determine an adjustment to the vent control valve based on the optimization model.

37. The system of claim 35, further comprising:
a compressor positioned between the electrochemical stack pressure control valve and the off-taker control valve,
wherein the compressor is configured to increase the pressure at the point of hydrogen gas delivery from the electrochemical stack to the off-taker, and
wherein the controller is further configured to determine an adjustment to the compressor based on the optimization model.

38. The system of claim 35, further comprising:
a variable area orifice meter configured to change a diameter of an orifice such as to provide a change in the pressure at the point of hydrogen gas delivery from the electrochemical stack to the off-taker,
wherein the controller is further configured to determine an adjustment to the variable area orifice meter based on the optimization model.

39.-40. (canceled)

41. The system of claim 35, wherein the operating conditions of the electrochemical system further comprise real-time operating data of the electrochemical system including power supply module data, electrochemical stack data, and balance of power usage data.

42. The system of claim 35, wherein the desired operating set points further comprise a hydrogen production rate at the point of delivery.

43. The system of claim 35, wherein the controller is further configured to control the electrochemical system by adjusting the off-taker control valve, the electrochemical stack pressure control valve, the power supply unit, or a combination thereof, for the operation of the electrochemical system based on the optimization model.

44. The system of claim 35, wherein, when an amount of hydrogen consumption increases at the point of delivery, the controller, based on the optimization model, is configured to:
adjust the power supply unit to increase the amount of current supplied to the electrochemical stack;
adjust the electrochemical stack pressure control valve to increase pressure on the cathode side of the electrochemical stack to reach the delivery pressure set point; and
adjust the off-taker control valve to maintain the flow rate of hydrogen gas, at the point of delivery from the electrochemical stack to the off-taker, with the desired operating set points,
wherein adjustments to the power supply unit, the electrochemical stack pressure control valve, and the off-taker control valve are configured to optimize delivery of hydrogen gas at the point of hydrogen gas delivery from the electrochemical stack to the off-taker.

45. (canceled)

46. The system of claim 35, wherein, when an amount of hydrogen consumption decreases at the point of delivery, the controller, based on the optimization model, is configured to:
adjust the power supply unit to decrease the amount of current supplied to the electrochemical stack;
adjust the electrochemical stack pressure control valve to increase pressure on the cathode side of the electrochemical stack to reach the delivery pressure set point; and
adjust the off-taker control valve to maintain the flow rate of hydrogen gas, at the point of delivery from the electrochemical stack to the off-taker, with the desired operating set points,
wherein adjustments to the power supply unit, the electrochemical stack pressure control valve, and the off-taker control valve are configured to optimize delivery of hydrogen gas at the point of hydrogen gas delivery from the electrochemical stack to the off-taker.

47. (canceled)
